(19) United States
(12) Patent Application Publication
(10) Pub. No.: US 2010/0255890 A1
(43) Pub. Date: Oct. 7, 2010

(54) Download management of audio and visual content, product method and system

(76) Inventors: John Mikkelsen, Minneapolis, MN (US); Robert Freidson, St. Petersburg (RU); John P. Luther, Chicago, IL (US)

Correspondence Address: LADAS & PARRY LLP, 224 SOUTH MICHIGAN AVENUE, SUITE 1600, CHICAGO, IL, 60604, US

(21) Appl. No.: 12/592,534

(22) Filed: Nov. 25, 2009

Related U.S. Application Data
(63) Continuation-in-part of application No. 12/322,615, filed on Feb. 4, 2009.
Application No. 12/322,615 is a continuation-in-part of application No. 12/322,618, filed on Feb. 4, 2009.
Application No. 12/322,618 is a division of application No. 10/183,756, filed on Jun. 26, 2002, now Pat. No. 7,548,875.
(60) Provisional application No. 60/301,681, filed on Jun. 27, 2001.
(60) Provisional application No. 60/303,115, filed on Jul. 3, 2001.
(60) Provisional application No. 60/312,450, filed on Aug. 14, 2001.
(60) Provisional application No. 60/343,159, filed on Oct. 26, 2001.

(51) Int. Cl. G06F 15/16; G06F 3/01; H04B 1/38

(52) U.S. Cl. 455/567; 709/247; 715/716

(57) ABSTRACT

An improved method for delivery and play back of sound and image files is provided as exemplary embodiments. This method may include the use of sound and/or image clips, which can be snippets or full files, as alerts for a variety of electronic devices or for playing on a handheld device, and for use as a promotion to sell items associated with the files. A collection or library of uniquely selected and/or edited clips may also be provided to the consumer in a manner far more conveniently on conventional telephone equipment than previously available. Exemplary embodiments may provide algorithms for the delivery, storage and playback of the sound files, including a delivery software system (500), a parametric optimization and compression algorithm (1600), and an error correction algorithm. In contrast to the conventional ring tones or musical chimes used to ring cellular phones currently on the market, the current invention provides a method for ringing cellular phones, electronic devices, and landline telephones with real sound recordings including real music, which may be songs sampled from copyright registered CD tracks, and may comprise human voice, various instrument sounds, and other sound effects of a high quality. A software based system for encoding the hardware of existing cellular phones at the time of manufacturing with delivery, storage, and playback capabilities in accordance with the exemplary embodiments may be provided, such that additional hardware may not be required.

### RELATED APPLICATIONS

This application is a Continuation-in-Part of Ser. No. 10/183,756, filed Jun. 6, 2002, now U.S. Pat. No. 7,548,875, which claims priority to U.S. Provisional Application Ser. No. 60/301,681, filed Jun. 27, 2001; U.S. Provisional Application Ser. No. 60/303,115, filed Jul. 3, 2001; U.S. Provisional Application Ser. No. 60/312,450, filed Aug. 14, 2001; and U.S. Provisional Application No. 60/343,159, filed Oct. 26, 2001, all of which applications are incorporated by herein reference.

### FIELD OF THE INVENTION

This invention relates to a method, system and products for the transmission, delivery, playback, and content management of audio and visual files for wireless and non-wireless devices, and a new Internet-less protocol for such transmission to portable electronic devices, such as cell phones and the like.

### BACKGROUND OF THE INVENTION

The cable transmission and delivery of audio files, such as music files, to portable phones with built-in MP3 players by way of a USB cable has been known for several years. For example, a Sprint PCS/Samsung cell phone which debuted sometime in 2000 and called Uproar included a RealNetworks' RealJukebox feature for managing MP3 files downloaded to the phone via a USB cable from a PC Internet website. The Uproar model included 64 MB of RAM allowing for approximately two hours worth of music file storage, and enabled a user to listen to music, for example, while waiting for an incoming call. A major shortcoming of this early cable-tethered phone-music device was the annoying length of time needed to transfer audio files to the phone usually taking around ten minutes to transfer several files. However, at the time, this device provided an attractive on-the-go compact phone/music delivery device with combined Internet access.

Since the advent of the Uproar, several mobile phones with integrated music players employing cable PC-music transfers have been introduced, none of which have yet achieved wide-spread acceptance approaching that of the music-only dedicated iPod portable digital player by Apple. One fairly recent example includes Sony Ericsson W800i Walkman with MP3 and AAC format, but which cannot integrate with PC-based jukebox programs. Another example is Audiovox SMT-5600 which works with Windows Media Player, a PC/phone music transfer, and which also enables the transfer of television shows. The PalmOne Treo 650 also uses Windows Media Player and music purchased from on-line music stores. Motorola's E815 powered by Verizon enables one to play songs off a TransFlash memory card, and allows for video streaming via Verizon's V Cast video service.

Within the last two years, the music/video enabled portable telephone market has literally exploded with many new devices and features rapidly transforming the cell phone industry and gradually displacing the PC as the sole media delivery platform, with the exception of television programming.

One of the latest expansions of media delivery to cell phones includes Sprint Movies, touted as the first pay-per-view service for mobile phones, which streams full-length movies on demand. Sprint has claimed to be the first carrier in the U.S. in December 2005 to offer any type of full-length movie on mobile phones with its mSpot movies.

The LG Fusic LX550 model released by Sprint is said to be the first multimedia phone of its kind to enable a user to download MP3's wirelessly, and is also said to include the first fax transmission in a cell phone.

Traditional cell phone service providers/hand set manufactures are also rapidly joining this fantastically expanding audio/visual delivery to cell phone industry as well. For example, Universal Music Group now plans to launch its own music-oriented cell phone service with a focus on ringtones and full-length song downloads, in similar manner as Virgin and Disney.

Recently, Apple Computer teamed with Motorola to enable users of the iTunes music store to transfer songs onto MP3-enabled cell phones coupled with a default jukebox. The resulting product, Motorola's ROKR phone, which required a USB cable connection to a PC for music downloads, was not well received. This was followed by the Apple branded LG Mobile phones Chocolate model powered by Verizon. The latest Apple foray into the market is the much hyped Apple iPhone, which still curiously requires a cable connection to download music files.

In other venues, a practice that is said to have started in Europe recently allows carriers such as Vodafone, Orange and O₂ to set up their own digital-music stores, letting customers download real music tracks over the cellular network to their phones.

A much sought after scenario would be for customers to use their mobile phones as digital jukeboxes, or even replacements or alternatives to television or PC's with some thought to dropping a digitally-enabled cell phone into a cradle at home or office/store or into a receptor in an auto or boat attached to stereo speakers. Memory capacity continues to present a technical barrier, however.

Additionally, it would also be highly desirable to implement a method and system for the effective management of the many music selections available. For example, Apple's iTunes Digital Jukebox is said to enable a user to play, sort, store and manage music selections. However, this system does not permit wireless remote management of various music selections, not to mention video and other selections by portable electronic devices, such as a cell phone, for convenience of travel and location away from the Internet, ISP connections and a PC.

In U.S. Patent Application Publication No. 2005/0144251, a cellular telephone download locker is disclosed for providing data files, such as ringtones, screensavers, games and other types of application software, to mobile phones. This method and system is Internet/ISP-based and users/subscribers can access a general purpose computer and their user-specific data lockers thereby via a URL link that is sent to users' mobile/phones by the system as a text message. However, this method and system is only enabled for monophonic and polyphonic ringtones, and is not capable of processing real music recordings.

As may be seen, solutions to the above-described problems are needed and would be highly desired.

The general concept for delivery of sound recordings or clips and visual recordings or clips by way of the Internet is known and described in various U.S. patent applications. (See, for example, Bernard et al., U.S. Pat. No. 5,918,213; Kaplan, U.S. Pat. No. 5,963,916; Barbara, U.S. Pat. No. 5,926,789; and Doerr et al., U.S. Pat. No. 5,949,41.) Such methods are typically used to sell products to consumers. For example, a web page from Amazon.com allows a user to listen to samples of music before purchasing compact discs (CD's) by mail.

Also, cell phones may be programmed to ring with an electronic facsimile of a real tune or a song or musical composition, and have become increasingly popular. Such electronic reproductions are known as monophonic and polyphonic tunes. However, cellular phones currently on the market can only be either programmed to only play music (such as conventional MP3 type phones) or to deliver “ring tones” with such electronic monophonic or polyphonic chime or ring tone rather than an actual recorded song, human voice, or musical composition. As electronic reproductions, such tones are devoid of real harmony, human voice and chorus, or at most only approximate harmony electronically with polyphonic tones. Additionally, these ring tones must be factory installed in the telephone or the delivery methods just directly interface with the Internet and require the consumer to be online to access and download a particular mechanical or electronically approximated ringtone.

More recently, various methods have been developed and are being used to enable a phone user to make more effective use of the variety of telephone services now available. For example, “caller ID” function is one such feature which allows the recipient of an incoming call to identify the caller based on textual information provided on a telephone system and method that determines the identity the person being called by sounding a distinctive ring associated with the person being called. A mechanical ringtone is played depending upon the caller ID signal received to orally alert the telephone user as to who is calling without reading the telephone's display panel. As may be seen, however, there exists much room for improved methods of delivery and playback of sound and image files on electronic devices, and especially the delivery of real music recordings, with real music instrument sounds, vibrato, human voice, chorus and harmony, as opposed to crude synthesized music, directly to cellular phones and the like.

Various Internet-based methods have been described for automated remote previewing and purchasing of music, video, software and other multimedia products, and eliminating the need for sales representative or other human operator interaction. See, for example, U.S. Pat. No. 5,918,213. In this method, users browse an automated menu on their computer screen which is equipped with prompts to guide the user through the system complete with product descriptions, and purchasing functions. This system may also be accessed by telephone, with voice descriptions of products provided, such as movie. However, all other information must be displayed on a customer's computer terminal.

Thus, it can be seen that there exists much room for improved methods of remote sampling, purchasing and delivery of music, especially real music recordings, movies, videos and other multimedia products and/or services directly over the air by cell phone for convenience and ease of use.

### SUMMARY OF INVENTION

In a preferred embodiment, the present invention provides a method for wirelessly delivering a digital media file, comprising audio and/or visual content from a central server or servers, or one or more servers in any location, over the air, to a wireless electronic device or by wireline, where there is an essentially limitless supply of personal storage area or capacity of for such data. In further preferred embodiments, the inventive method and system comprises executing at one or more server or servers algorithmic means to optimize and compress the digital media file; storing optimized and compressed digital media file on a storage medium; selecting by the user with our without an Internet connection, the digital media file comprising one or more of full or partial master recordings of songs, musical compositions, videos, films, television shows, personal recordings, cartoons and combinations thereof; and executing by one or more server transmission means to transfer the optimized and compressed digital medial file from the storage medium by way of one or more wireless channels to the wireless electronic device, wherein the wireless electronic device comprises means for receiving and playing back by the user the optimized and compressed digital media.

The present inventive method and system is more fully understood with reference to the following Detailed Discussion of Preferred Embodiments and the accompanying drawings.

### BRIEF DISCUSSION OF THE DRAWINGS

FIG. 1. is a general scheme illustrating the basic operations of the present invention.

FIG. 2 is a general schematic diagram illustrating the basic components of a wireless transmission system for a landline or cellular telephone.

FIG. 3 is a schematic diagram of a wireless transmission system for a cellular phone.

FIG. 4 is a schematic diagram of a board system implemented in an accessory unit of the system of FIG. 3.

FIG. 5 is a schematic diagram of a server software system for the system of FIG. 3.

FIG. 6 is a flow chart illustrating a data transmission method.

FIGS. 7 A-D illustrate the electrical schematics of a mobile telephone accessory unit in accordance with the present invention.

FIG. 8 illustrates an image of a printed circuit board for the accessory unit of FIGS. 7 A-D.

FIG. 9 is an exploded side view illustrating the assembly of a cellular phone accessory unit and cellular phone attachment to the accessory unit.

FIG. 10 is a perspective view of the cellular phone accessory unit and cellular phone of FIG. 9, showing the cellular phone attached to the back of the phone connector and mounting of the accessory unit.

FIG. 11 is a perspective view of the accessory unit of FIG. 9, detached from the telephone.

FIG. 12 is a perspective view of the accessory unit of FIG. 9, disassembled from the mounting.

FIG. 13 is a schematic diagram of a landline transmission system for a home telephone.

FIG. 14 is a schematic diagram of a board system implemented in an accessory unit of a home telephone utilizing the system of FIG. 13.

FIG. 15 is a schematic diagram of server software for the system of FIG. 13.

FIG. 16 is a flow chart for an audio data parametric optimization and compression algorithm.

FIG. 17 is a schematic diagram of a protocol for a data transmission method with error correction delivery for a digital cellular telephone, illustrating individual packet acknowledgement for a full-duplex channel case.

FIG. 18 is a schematic diagram of a protocol for a data transmission method with error correction delivery for a digital cellular telephone, illustrating single acknowledgement for all packets for a half-duplex channel case.

FIG. 19 is a schematic diagram for a media file monitoring system.

FIG. 20 is a conceptual diagram of a delivery system, which includes an advanced cell phone system, and other devices, which can access a content server.

FIG. 21 is a schematic diagram of an advanced cellular phone system running client software in accordance with the present invention.

FIG. 22 is a schematic diagram of the software for the system of FIG. 21.

FIG. 23 is a front perspective view of an accessory unit, having a fish tail design, shown attached to a cellular phone, in accordance with an alternate embodiment.

FIG. 24 is a side view of the accessory unit and phone of FIG. 23.

FIG. 25 is a preferred example of a schematic illustrating content optimization and adoption.

FIG. 26 is an additionally preferred example of a schematic content optimization and adoption.

### DETAILED DISCUSSION OF PREFERRED EMBODIMENTS

In its broadest sense, the present invention is directed to a product, method and system comprising a software product, or more particularly, downloadable product software, or software pre-installed by a manufacturer and/or user and the like, which is effective for a user to manage for personal and business uses, or any use, a wide array of audio and visual digital content. The term “manage” as used herein is intended to encompass its broadest possible meaning, whether within any dictionary definition or specialized usage, and includes at a minimum the surveying or “surfing” of a menu and/or selection of audio and/or visual content comprising goods and/or services (for simplicity hereinafter “items”); downloading and/or storage of selected items; and further optionally comprising listening to and/or viewing selected items utilizing an electronic device, such as an electronic digital device, including, without limitation, a cell phone or PDA device, for instance, a Blackberry type device. For simplicity, the software product is referred to herein by applicants' trademark “Download Manager”.

An example of one scenario of utilizing an embodiment of the invention may be a user of a cell phone dialing a service provider, such as by any code or perhaps a toll-free number, or by contacting a service provider by an SMS and/or MMS text or multimedia message. A menu or selection appearing on the cell phone display screen may include virtually any audio and/or video or imagery content display, including, for example, without limitation, a selection of real music recordings, a selection of clips from real music recordings for use as ringtones, alerts and the like, a selection of videos, animations, various documents comprising text and/or imagery, such as books, reports, editorials, musical and/or scientific compositions, legal documents, tax documents, tax calculation products, and the like, which content is essentially only limited by one's imagination.

After viewing the display, the user may then, by way of Download Manager, select each desired item, such as by a “one-click” action or function using the phone's keypad, such as a conventional DTMF or any effective function enabling the user to consummate a selection by way of the cell phone, or any other electronic device.

Upon selection, the Download Manager product of the invention will then “bundle” the items selected, or produce a shopping cart of selected items, which can then be downloaded into an interim storage space or portal and the like, and which does not occupy or cache in memory of the electronic device employed by the user. The user may then, as desired, download or otherwise access particular items into or via a cell phone for use, e.g. for listening and/or viewing. In effect, Download Manager enables the user to manage all items for present or further contemplated usage without using the limited memory of the cell phone, PDA or other electronic device, and which provides a viable and valuable solution to the long complained of memory and storage exhaustion in just about every probable electronic device in existence or on the drawing board.

As may be readily apparent to any one with any exposure to portable electronic devices playing music, movies, videos, etc., the present invention inclusive of Download Manager enables a user to “bundle” or otherwise stockpile for contemplated usage a virtually limitless amount of purchased or otherwise delivered audio and visual items. For example, and more importantly, for comparative purposes with conventional technology and products, the present invention may allow a user to stockpile or store for future immediate use, or immediately on demand, in excess of, say, one-hundred thousand digital music recordings, as opposed to a product such as VCAST which allows a maximum of about thirty. The magnitude used in this example of in excess of one-hundred thousand is just that—an example, as the present invention in fact enables the storage of audio and visual services and products for immediate use as desired in virtually limitless quantities.

It is envisioned that individual users may possess a private code or password, such as a PIN, for access to their personal storage lockers of selected digital, audio and visual items.

The invention may be better understood with reference to the following exemplified embodiment set out below in Example 1.

Example 1.
Step 1. A user dials a telephone number or actuates an access code of some sort to deliver a menu to a cell phone display screen.

Step 2. The user selects a topic from the display, such as “Games and Applications” and a second display appears as follows:
Games and Applications
New Games
Golf
DYNO
Wallpaper
Real mastertones, ringtones
Music
Videos
Download Manager
Step 3: The user selects and actuates the “Download Manager” icon.
Step 4: The screen display is changed to the following:
   My Downloads
   Master recordings
   JAVA (games)
   Ringtones
   Videos
   Etc.
Step 5: Any item referenced in “My Downloads” (possibly hundreds, or thousands of items or more), can be selected for immediate download and use on the cell phone.
Step 6: (Optional)
   The user may remove any item or items as desired, or add new items to a storage locker or, say, one's PC, by access to a limitless shopping mart or mall via the user's cell phone, or other electronic device, with or without an Internet connection.
Step 7: (Optional)
   Any transaction, or function of selection, downloading, listening, and/or viewing may be keyed to a fee which may be automatically charged to one's cell phone service provider account, or be billed or charged to any electronic account or any account at all, employing any of several conventional methods and technologies.

In other aspects of the invention, it is contemplated that a storage locker, or storage locker capability in accordance with the present invention, may be effectively implemented on any retail and/or service orientated website, such as, for example, the L.L. Bean customer sales website, or perhaps Macy's or COSTCO's websites and the like. The inventive product, method and system allows, inter alfa, a customer, or potential customer, to access a storage medium, such as a personal storage locker, optionally with a security code, such as a PIN, to contemplate purchases as desired, for example, to view purchases, organize purchases, view and/or organize dates of purchase, receipts, possible store or product refunds or discounts which may need to be acted upon, and the like. The inventive product, method and system also allows a customer access to a storage medium, such as a personal storage locker, via a mobile device, such as a cell phone, to contemplate purchases, to organize purchases, and the like, and concomitantly, in real time, update and/or refresh a storage medium as displayed on a PC, laptop or computer device, and substantially simultaneously as displayed on an electronic device, such as a cell phone, e.g. a PC synchronized to a cell phone or visa-versa in real time. Thus, one may, as desired, in accordance with the invention, organize such items or files as diverse as personal tax files, insurance documents, banking files and documents, as well as consumer purchases, automobile warranty and maintenance information, and essentially any product or service offered for sale or otherwise transferable and/or obtainable either online or via conventional on-site store locations.

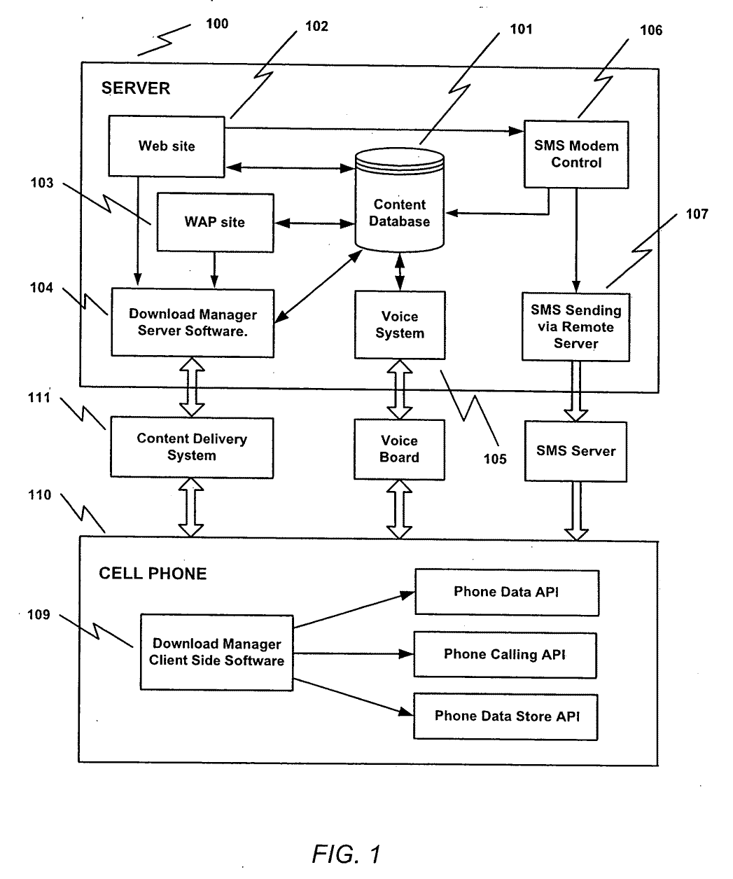

A further preferred embodiment of the present invention is set forth in FIG. 1. Here, a Telephone Initiated Protocol Improved Media Delivery Platform, as set forth in co-pending U.S. application Ser. No. 12/322,537, filed Feb. 4, 2009 all of which is expressly incorporated herein by reference, is exemplified employing the present inventive Download Manager Product Method and System. As shown, in this system example a central database, or otherwise a phone content and users' database (content database) 101 is the main content “commissary” of digital audio and video subject matter comprising transmittable goods and services, such as games, wallpaper, musical compositions, snippets of real music for use as ringtones, etc., videos, movies, textual materials, such as business, financial, tax and legal documents, banking information and documents, imagery, such as personal photos, optionally coupled with other personal information, such as for dating and chat purposes, artistic compositions or teaching instruction or research information, such as mathematical and chemical formulae and the like, or in essence essentially everything and anything that can be transferred as digital content by any wireline and wireless channels in streaming or compressed format.

The content database 101 may be situated in one or more servers, generally depicted by server 100. As further shown, subject matter from content database 101 may be selected and ordered, or otherwise requested, by one or more users by any one of an array of conventional venues such as a web site 102, a wireless applications protocol (WAP) site 103, by voice system (IVR) 105, or by SMS/MMS text and multimedia messaging by either modem control 106 or sending via a remote server 107.

The Download Manager feature of the invention preferably comprises server-side software 104 and downloadable client-side software 109 which can be downloaded and stored on a user's portable electronic device, such as cell phone 110 as shown. Server-side software 104 maybe designed to be effective to assemble and/or update and manage a user's or customer's digital subject matter content portfolio or library, and to enable the user to assemble new services, products and information by way of a user's electronic device, e.g. cell phone 110, over the air, or by any wireline connection. The client-side application 109 creates a content list or library for download and storage to the user's cell phone 110, and preferably supports a direct correspondence between a website 102 and cell phone 110, optionally via WAP site 103, for the purpose of storing and delivering software applications and data bundles fast and efficiently in a one-cost effective package. User's may thereby be provided with direct access to new or existing content, or otherwise services and products, with a “one-click” purchasing or selection capability, with an up-to-date content. In a further preferred option, the content list may be updated to the cell phone device, handset, or PC automatically when a customer or user opens the content list or library on the user's mobile phone.

As further shown in FIG. 1, the screen or keypad of a portable electronic device may include a registration or content selection process, and the system may encompass one or more content delivery systems 111. There may be a manage content selection list. Updated information may be sent to a voice system, e.g. IVR 105, and the content database 101 may receive user action information from the voice system for execution.

Thus, as shown, some highly desirable features of the present invention enable a user to have their mobile content library and desktop/PC library sync in real time upon a user adding new content or deleting existing content, such upon a “refreshing” action. Users may add new content or delete existing content while working from a desktop PC with their specific content library changes automatically updating their wireless (or wireline) device in real time synch. In similar manner, a user will have the ability to add new content or delete existing content while working from their wireless (or wireline) device with their specific content library changes automatically updating a configured desktop/PC in real time synch.

Users will have the unheralded ability to preview and store literally thousands or perhaps hundreds of thousands, or more, of content files in a personalized, or any, download manager storage medium using zero cache storage space on their wireless (or wireline) device, upon the user's desire to download content from a download manager storage medium, such as exhibited on the deck of a phone, to download the desired content. To rephrase the invention in other terms, the presently inventive download manager feature is a client software product downloadable over the air (or via wireline) to a user's wireless (or wireline) device, which enables a user to sample, select and purchase digital audio and/or visual content from a content store, such as a content database 101 described above. The user is then enabled to manage the selected and purchased content, automatically updating an array of electronic devices, such as the users' PC and cell phone.

A preferred method and system for use with present invention is that disclosed in co-pending U.S. patent application Ser. No. 10/153,756, filed Jun. 26, 2002, entitled “Media Delivery Platform”, the entirety of which is incorporated by reference herein, and an Improved Media Delivery Platform, the description of which follows below.

Use of Sound and/or Image Clips as Alerts for Electronic Devices

According to one embodiment, the system allows for sound and/or image clips, which are snippets of a musical and/or visual performance piece, to be used for sound and/or image alerts, such as ringtones, in any one of a number of electronic devices, such as cell phones and the like. A library or collection of uniquely edited clips may be provided to the consumer for browsing and selecting files to be stored on the electronic device. The consumer may also use home made personal clips (e.g. personal sound recordings, family photos, home movies, etc.).

The sound and/or image clips may be lifted from CD's, movies, TV shows, and the like, and are actual recordings, which may include human voice, instrument sound, and other sound effects, rather than mere electronic chimes or tones as those produced by conventional cellular phones, such as polyphonic and monophonic facsimile reproduction of real music.

Electronic devices which may utilize sound and/or image files or clips as alerts or ringtones include, but are not limited to, cellular phones, land line phones, computers, clocks, watches, pagers, door bells, car alarms, palm pilots, headphones and personal calendars or in any other product where a ringtone may be useful. It should be understood that although using clips for alerts is preferable, full, unedited files may also be used.

According to one embodiment, real sound and/or image clips are used to “ring” a cellular or home phone, such as real music clips. A clip or series of clips, which the user can select, are played instead of the conventional electronic chime or ring tone. Such a system may be implemented on conventional cellular phones, which may be analogue or digital, by downloading firmware, comprising algorithms for delivery, storage, and playback of the sound files, to the RAM element of the phone. Such algorithms may include a delivery method algorithm and a parametric optimization and compression algorithm, and may further preferably include an error correction algorithm. Alternatively, an accessory unit that attaches to the cellular phone for implementing the system of the present invention may be provided.

According to another embodiment, sound and/or image clips are used for computer alerts such as e-mail notification sounds. Clips may also be used to ring a doorbell. Sound clips may further be used by a clock or watch to sound at the beginning of each hour, similar to a grandfather clock, wherein a different sound clip may be played at each hour.

The present invention allows the user to store hundreds of different alert clips on a device. Unlike conventional electronic equipment which hold a limited number of selectable alerts, such as a conventional car alarm or music player alarm clock, the present invention allows the user to choose from an unlimited number of clip files, including allowing the user to create his own alert clips or to choose from a library of uniquely selected and/or edited files, including samples taken from CD's, movies, television shows and the like.

A cellular phone or similar device (having a processor, RAM, and preferably flash elements) may be integrated with software at the time of manufacturing for implementing the system of the present invention. Alternatively, a chip may be embedded into the device or an accessory unit, including a speaker, attached to the device for implementing the system of the present invention. The accessory unit may have an adapter connection to the device. Such accessory unit may be sold with several adapter outlets to enable it to fit onto a variety of different electronic devices such as any number of different cell phones not initially enabled with digital compression sound and/or image play technology/capability.

Sound and/or image clips may be pre-stored on the electronic device or accessory unit at the time of manufacturing, such that the consumer may be able to used the clips for alerts, without first having to select and download clips.

A user of an electronic device, according to the present invention, may download and store a number of clips off a website via a plug-in connection of the device to the computer, or via a wireless network system such as the Applet Airport. Additionally, a non-Internet based holding system, such as a remote server which may be especially adapted for delivering files or clips to the electronic device or accessory unit in accordance with the invention, may also be provided. Such a holding system may be accessed via a phone dial, i.e. phone keypad, in connection wherein a user may interact with the holding system by using the phone keypads or voice commands. Other controls for interacting with the holding system, such as control buttons, voice commands or text keypads, may be provided on the accessory unit or the electronic device itself which may be especially adapted for interacting with such holding system. The accessory unit or electronic device itself may also be sold preprogrammed with embedded clips for demonstration use.

Additionally, such electronic devices may be capable of receiving or sending clips directly from one device to another device. To prevent transferring of entire files from one device to another, a security feature may be included on the devices and work in conjunction with the file.

One method of preventing the transferring of files is to encode each electronic device or accessory unit with unique scrambling/un-scrambling wave capabilities. As such, when a user transfers an entire file to his device, say a cellular phone, for which he pays a fee, a scrambling wave, which may be a function of his unique telephone number, may be encrypted in the file.

Upon playing the file, the user's cellular phone sends the corresponding unscrambling opposite wave. Other devices purchased by the same user may also include the unique scrambling/unscrambling have encryption capabilities associated with the user's telephone number. As such, the files may only be played with clarity on the device or devices owned by the user, even if such files are transferred to other devices.

Another method of preventing the transferring and reproduction of files is to use subscriber identity information of a telephony SIM card as an authorization key that would enable the user to be authorized. Based on this method, the user's authorization key may be transmitted to the holding unit when the user requests the server, for example, to download a selected music clip file, wherein the key is encrypted in the file. After the clip file has been downloaded from the holding unit to the cell phone, the encrypted key may be compared with the actual subscriber identity information, for allowing use of the file only if the identity is successfully matched.

The security lock mechanism allows the original digital audio and/or image content distributor or its representative to control distribution of digital content such as music, and also provides an opportunity for such content distributors, such as music distributors, for instance, Universal, to keep track of who plays their music. As such, a method of accounting for royalty payments to artists and performers and other parties registered with performing rights organizations such as ASCAP and BMI may include providing a tracking feature on electronic devices used by businesses such as bars, restaurants, and clubs to play music. In addition to allowing a record to be kept as to which digital content files have been downloaded and stored on the electronic device, the tracking feature may also record information, for example, as to how many times and when each particular song has been played. This allows performing rights or music writers' organizations the ability to keep an accurate record on which to base royalty payment distributions.

An electronic device having stored sound and/or image clips may include various features, which allow the user to pre-program the clips to play in a set sequence or a random order. For example, certain clips, which may be from the same or different songs, may play in a congruous or back-to-back order with a fixed silence time between the clips. Additionally, the device may have features allowing the user to classify and arrange content clips based on categories such as the type of clip, i.e., movie, song, etc., artist name, time period, etc.

Thus, a user of an electronic device utilizing the content according to the present invention will be able to arrange the clips either through a website from which the clips can be downloaded onto the device, or through the device itself, such as from a keypad of a cellular phone.

Additionally, after listening to or viewing a clip, the user can choose to download the entire file from where the clip originated (i.e. the entire movie, song, etc.). The server providing the clips and the files may provide the clips for free or, for example, for a relatively small fee as inducement for the consumer to ultimately download the entire file for which a greater fee may be charged.

An electronic device according to the present invention may also have the ability to receive clips, which are directly transmitted onto the electronic device via audio or visual broadcasts. The user of an electronic device may program the device to sound a specified broadcast as an alert sound. For example, a sound segment from a live radio show (i.e., a sports show or a commercial) may be used to ring a cellular phone by either the caller or the callee.

Advertisements may also be transmitted through the electronic devices according to the present invention. For example, a message such as “pick up the phone and don't forget to drink Coca Cola™” may be used as an alert or as a ringtone of an incoming call. However, such transmitted advertising messages need not necessarily function as alerts, but may be used via the present invention in exchange for a user receiving free music and/or other audio and visual content, very much in the same manner as television commercials are presented either on free or cable TV.

Additionally, this invention contemplates the use of image and sound clips, which can be combined such that the user can create a unique clip of both sound and image for use in electronic devices having display screens. For example, a phone having an appropriate display Screen can be pre-programmed to display a visual clip of a caller accompanied by sound, or a computer alert may display an image clip with sound. An image clip may comprise a single image frame or a picture clip as well as an animation.

Website to be used as a Support Tool for Downloading Clips to Electronic Devices and Method for Selling

According to a preferred embodiment, a website for downloading sound and/or image clips holds a library of clips, each clip having a specific identifying code or icon which may include, for example, the title of a musical composition or movie from where the clip originated, the name of the artist, a code number, or other type of identification depending on the type of clip. For example, a song clip may be listed as barrywhite@lovestuff. av, or may display the picture of the song artist or CD cover of the CD on which the song appears, along with the name of the song. The list may be organized according to the artist's name, by music classification, e.g., classical, country, pop, jazz, blues, R&B, hip hop, etc., by length of the sound clip, by the type of sound clip, e.g., song, piano music, guitar music, loud, quiet, etc., or any combination of these categories or other conventional categories depending on the type of clip (image or sound). The website may also include categories of longer clips which may be more suitable or desirable for phone rings, and shorter clips which may be more suitable or desirable for computer alerts. The website may further-contain a suggested list of weekly or daily favorite clip picks, which may be provided for each category or subcategory. Additionally, items or subcategories in a given category may be organized alphabetically, by year of copyright, or any other conventional order.

### Example

Tables 1 and 2 below are examples of possible arrangements for sound clips using music classification and artist name. Note that the listings of Table 1 such as barrywhite@lovestuff.wav are not websites, but use symbols associated with web use, such symbols being one of the many arbitrary ways of listing the clips. The symbol-driven website-like listings may end with other non-suffixes such as “.pop”, “.song”, etc. Additionally, this invention contemplates the use of website hyperlinks associated with each listing as shown below in Tables 1 and 2.

TABLE 1

| R&B | Jazz | Rock |
|---|---|---|
| Barry White | Herb Albert | Chicago |
| barrywhite@lovestuff | herbalpert@sunspots.pop | chicago@fellings. |
| | | wav |
| barrywhite@deepvox | herbalpertgdatingame.pop | chicago@time.wav |
| R&B | Jazz | Rock |

TABLE 2

| Barry White | Herb Albert | Chicago |
|---|---|---|
| BW-01 A-Sexy | HA-01 A-Date | C-01 A-Begin |
| BW-02 A-Love | HA-02 A-Bull | C-02 A-Search |
| BW-03 A-Peace | HA-03 A-101 | C-03 A-Color |

The clips may also have an identifying number associated with each clip. Such identifying numbers may be used in downloading the clips to an electronic device using a telephone (described below) or other device having a number keypad. The website may further include a virtual personal locker or storage area for storing a selection of clips personal to a user which can be accessed on the website by a unique user identification name or code. As such, a user can store clips for later purchasing, downloading to the user's cellular phone, playing, etc.

The website may also allow the user to upload personal clips such as family photos, voice recordings, home movies, and the like, to the storage locker for later downloading to the user's cellular phone or other electronic equipment. The storage locker may include an organizer for storing the clips in alphabetical order, by various categories, or any other order. The website may allow for direct downloads of the clips from the website to the computer itself or to other electronic devices.

To illustrate how downloading through the website may be carried out, a user operating the computer may drag his/her mouse over the various listed sound or image clips and click on one or more selected clips. Thereafter, a box can appear prompting the user to select the appropriate electronic device onto which the clip or clips are to be downloaded (e.g., the box may say CELLULAR PHONE DOWNLOAD OR COMPUTER ALERT DOWNLOAD?” Assuming that the “CELLULAR PHONE DOWNLOAD” button is selected, a prompt for typing in the appropriate cellular phone number will follow. Thereafter, the selected clip or clips may be uploaded to the user's personal locker and made available for downloading to the user's handset.

Other features may also be included, such as an option allowing the user to arrange multiple downloads in a specific order, create a folder for grouping multiple downloads, or a feature incorporated into the phone which causes it to ring a selected clip immediately after it has been downloaded. Additionally, clips, which have been previously downloaded to the phone may be deleted, rearranged, or reclassified with or without using the website. The invention contemplates additional methods for storing clips on an electronic device, such as a cellular phone, some of which are described below, including direct downloading access for phones without the need for web phone access capabilities.

Alternatively, by clicking “COMPUTER ALERT DOWNLOAD,” the selected clip will be downloaded to the user's computer, allowing the user to select many different sound and image clips for computer alerts, such as e-mail notification, computer alarm clock, and computer calendar notification.

Additionally, multiple clips may be associated with one type of alert, such that a different clip is played for each alert event. The user will be able to rotate alert clips and preprogram or randomize their order similar to a CD stereo carousel.

The user will also be able to hear or view a selected clip which will play on the website upon the user's command. Browsing capabilities wherein the user can drag his mouse over the sound clips library of selections and hear the clips without having to click or open a file may be included in the website. According to a preferred embodiment, a user simply drags his mouse over various clip samples, which light up or flash and play one at a time. For example, any time the user places the cursor over a category of music, the first tune in that category plays, and the icon representing that category of music switches to display the name of the artist and title of the song or composition being played. Once the user clicks upon that icon, he can select the next song and hear the song while at the same time seeing the name of the artist and song title. The user can cycle through all the songs within that category using this approach very quickly to not only browse but to also bear the music. If the user does not wish to switch over to another category of music, he simply moves the cursor to another icon and repeats this procedure. To select a particular song the user may double click on the song, which is then included in a collection of selected songs to be downloaded later.

In yet another aspect of the invention, the website may be used as a shopping forum where consumers can hear or view the clips and click to buy items, e.g., “one-click purchase option” associated with the clips such as music records, cassette tapes and CD's, DVD's, and movie videos, or download the entire sound or image file to their computer for a fee. By allowing the user to sample and download clips for use as alerts in electronic devices, the website will provide an attractive forum for selling items associated with the sound and image clips, and for allowing the user to download the entire file associated with the clip, for which a fee may be charged.

Additionally, an identifying mini icon, such as the song title or recording artist CD icon associated with a clip or with a group of clips, or movie title, etc., may appear on the computer screen at a fixed location and/or at the screen display where the clip plays a computer alert. The icon may include a “buy” button, which will allow the user to purchase an item associated with the clip, or download the entire file from which the clip originated by clicking on the button. Such “buy” button may be a hyperlink to a website for transacting the purchase, and a purchase fee may be automatically associated with a telephone number. Where a CD icon is not used, the user, for example, may click on a song title to purchase an item associated with the clip. In another example, if the clip comes from a song or movie that exists on more than one CD or DVD, the customer will see more than one CD or DVD cover to choose which CD or DVD to buy.

The utility of clips as alerts or ringtones for electronic equipment will provide consumers with incentive to browse the website and sample the clips. After hearing or viewing the clip, consumers may be induced to purchase items associated with the clips, such as hats, t-shirts, clothes, etc; which they will be able to do instantaneously through the website by the click of their mouse.

The website may further be used as a contest forum. The website may be set up to play mystery clips or short segments of sound and/or image files which contestants will have to identify in order to win a prize, e.g., by being the first to e-mail or call with the correct answer. Thus, a radio show may set up a game where a short segment of a sound and/or image file is played on the radio or user's phone for contestants to guess and is also available for the listeners and viewers who want to hear and/or view it again on the website.

The website may include forwarding capabilities, such that a sound or image file or clip can be forwarded as a greeting to a friend. A security feature may be used only to prevent transferring of entire files. Consequently, the website will attract customers for the purpose of downloading clips to electronic devices and ultimately purchasing items associated with the clips. Additionally, the user may subscribe to a service such as an existing cell phone service provider for downloading audio and/or visual files through their telephone, without having to be online, i.e. without the need for an Internet connection.

The user may also create a clip (e.g. by recording a song, movie or personal clip) and store the clip onto a sound and/or image storage element in the electronic device. Additionally, the electronic device can be preprogrammed with clips selected by the manufacturer retailer of the device.

Accessing of Sound and/or Image Files without Access to Internet

Sound and/or image files which include clips may be downloaded without use of the Internet, i.e., without the need for an ISP connection, by allowing a user to access a library of clips via their cellular phone or home telephone or providing other electronic devices with features which allow automatic access to the library. Although Internet free-accessing will be described with respect to a telephone, it is to be understood that the method described may be compatible with any electronic device preferably having accessing capabilities similar to a telephone.

The library may be a non-web holding unit such as some sort of remote sever that has files with associated codes which match the codes associated with the files on the website, wherein the website serves as a usable guide for identifying various files according to associated codes, such as numerical codes to assist the user in downloading files using voice commands or keypad commands.

Additionally, cellular phone or home telephone users may access a non-web holding unit with a library of stored files which can similarly be browsed, selected, and downloaded onto the phone using user voice commands, key pad commands, or by connection to a live operator. Such unit may be accessed by dialing a phone number, such as an advertised telephone number e.g., an 800 number or other toll-free number. Home telephones and cellular phones may have separate holding units, such as a satellite for cellular phones and a ground unit for home phones, or a satellite can be used by cellular phones to access a ground holding unit.

To facilitate selection of the files from such holding unit, the access system may provide for a code associated with each file which may be obtained by browsing the website as described above. As such, a user connected to the holding unit would access the code associated with the file to select and download the file to the user's telephone.

Many other methods allowing a user to select files from the holding unit are possible in accordance with the invention. For example, the telephone may include a voice recognition feature, wherein the user, for example, can say the name or part of the name of the song or movie s/he wishes to select (e.g., “Strawberry Fields” or the name of the song artist, or “Good Fellas” or a documentary such as “Fahrenheit 911”). The phone may also utilize hierarchical submenus whereby the user may press dial keys with letters corresponding to a selection in a given category, which ultimately leads to the selection of a particular song or movie, or image file and the like. A phone having a screen display for providing a text listing of the names of sounds and image content files or categories, according to hierarchical submenus, may also be used for enabling the user, for example, to narrow down to a list of songs and/or artists from which s/he can make a final selection.

A telephone may likewise be used to deliver files stored on the phone to a website, an email address, another telephone, or other electronic device. Sound and/or image clips, which may be segments of whole songs or movies or animations, musical compositions or other sound recordings, may be the most likely to be used with telephones, however, downloading entire music or image files may also be done, subject to the security feature described above. Additional revenues may be generated as the consumer accesses the content library and uses airtime while browsing and downloading clips or entire sound and/or image files from the library holding unit.

Furthermore, cellular phone and home telephone service providers may offer extra features to phone subscribers which would allow the subscribers to download and store sound and/or image files for use with the telephone in accordance with the present invention. Such features by service providers may include a personal sound and/or storage medium (which may be a file of clips and/or entire sound and/or image files) that the user can access via a personal code. The user may be charged a monthly fee for a subscription to the service, and/or per downloading of each sound and/or image file, whether or not the user is a subscriber. Additional revenue can be generated by the service provider even if the service is provided without a special charge since consumers will use more airtime.

Telephone Using Sound and/or Image Files

A telephone having stored sound and/or image files, which may, for example, comprise real music, including human voice, various instrument sounds, and other sound effects, or movie segments with or without real music, may allow the user to select one file or file segment or a rotation of several files or segments to “ring” the phone. Although it is preferable to ring the telephone with clips, an entire sound and/or image file, such as a music file may also be used, whereby for example, a song may start playing and continue until the user picks up the telephone. Of course, entire sound and/or image files, such as an entire song, may be played on the telephone solely for the user's listening (or viewing) pleasure. The telephone may also be programmed to ring a conventional chime if the user so chooses. Such a telephone may utilize a storage chip carrying stored sound and/or image file as well as the conventional phone chime programmed onto it.

Additionally, the telephone may allow the user to determine how many times a file or clip is to repeatedly play for each “ring”, and the time delay between clips in a given ring. The user may also choose to mix different clips in one ring. A telephone may also include a looping feature which rings the telephone in a looped clip such that the clip plays repeatedly without a pause between repetitions of the clip, or a “cluster” feature which rings a “cluster clip” comprising a multiple number of clip segments from a single song, musical composition, or other sound and/or image file played in sequence.

Other features will allow the telephone user to pre-program the telephone to play a certain clip when a specific individual calls, thereby allowing the user to identify the caller based on the chosen sound and/or image clip. Each person who regularly calls the user may have a unique identifying ring. This will allow a telephone user to have the option of assigning a unique sound and/or image caller ID to each of an unlimited number of callers.

Other features may include allowing a caller to select his own personal sound and/or image file or clip to “ring” the telephone of the recipient of the call. For example, a caller may sing or record a “Happy Birthday” song. Also, a telephone used by more than one user may utilize sound and/or image files for a callee ID function wherein the caller identifies the intended callee (e.g., by dialing a digit or sequence of digits) and the telephone plays the file associated with the callee.

Additionally, a telephone may be provided with a “caller message recorder feature” which allows the caller to record his/her own message to send to the number dialed. For example, the caller may send a message such as “Hey John. It's Mary. Pick up the phone,” by pressing a “record ring” button on his/her phone to send such a message to John's phone. As described earlier, the telephone user, say John, may have a caller ID feature such that when a certain caller, say Mary calls, the telephone rings with a predetermined message or sound and/or image file selected by John. The additional caller message recorder feature may cause John's telephone to play Mary's message instead of overlaying the predetermined caller ID message or clip. Additionally, John may record his own message such as “It's Mary”, and perhaps with an image or movie segment involving Mary and associate that recorded message with Mary's phone number for a caller ID ring.

A telephone, according to the present invention, may also include a “sensory feature” for enabling the telephone to sense the level of ambient noise and adjust the loudness of the “ring” accordingly. If the phone “senses” very loud background noise, for example, a cellular phone located in a loud restaurant, the ring volume will increase. A feature for detecting whether a cellular phone is located in a pocket book or a place where the “ring” sound may be muffled is also contemplated. This feature will also enable the phone to adjust the volume of the “ring” such that the “ring”, e.g., a sound file in accordance with the invention, will be loud enough for the user to hear. Such detection mechanism can be achieved by detecting ambient light and other conditions.

Additionally, the user may manually adjust the volume of the ring via a tunable volume control mechanism or a multiple fixed settings control. Although the above features are described with respect to a phone, it is to be understood that these features may also be provided with other electronic devices utilizing sound and/or image clips as alerts where applicable.

Transmission System for Delivery of Sound and/or Image Files to a Telephone

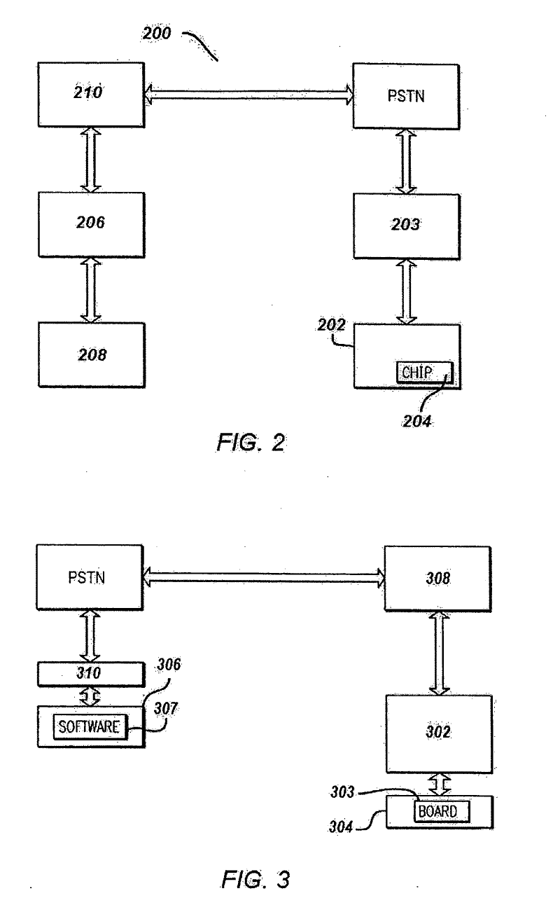

FIG. 2 is a schematic diagram illustrating in a preferred embodiment, the basic components for a wireless transmission system 200 for a telephone 202, having a wireless or landline service provider.

The system is described in terms of two main components: a storage chip 204, and a server 206. The storage chip 204 is an element associated with the telephone, which may be embedded into the phone or into an accessory unit which attaches to the phone, having abilities to interface with the phone. For example, any “non-music” phone currently on the market may be so enabled in accordance with the present invention by attachment of an accessory unit. The existing hardware of a cellular phone may also be integrated with a software system, which may be downloaded to the RAM element of the cell phone for incorporating the present invention, without the need for extra hardware. As such, the existing hardware of the cellular phone may be made to perform the same function of the chip.

The purpose of the chip 204 is to store a selection of files, allow for downloading of files to be stored on the chip 204, and allow for the playback of files, either by the telephone or the chip 204. Although the description herein refers to sound and/or image files, it is to be noted that both entire sound and/or image files or segments of files, or “clips” may be stored, downloaded, and played, according to the system described. Additionally, the chip 204 can associate the stored files with a caller ID so that the particular file to be played back is determined by the calling subscriber ID.

The server 206, which is associated with a collection of stored files 208, is designed to execute requests of the chip 204, which may be given through user voice commands or commands using the phone keys. The server may be equipped with a voice adapter 210 for supporting the ITU-T V.253 standard and telephone lines attached to the voice adapter. The voice adapter can also support some standard modem protocols, like V.32 or V.34, if required for compatibility.

The server 206 also allows for files to be transmitted to the chip 204 for storage. The system 200 enables a connection to the server 206 upon a request from the chip 204, utilizing the phone, and/or PSTN (Public Switched Telephone Network), and/or a voice card (voice modem) attached to the server computer, or otherwise any wireless on wireline channels.

The system may have a voice menu, which, after connection to the server 206, allows the user to listen to the server's menu and navigate through the system of voice menus using a telephone's Dual Tone Multi Frequency (DTMF) keys. The system may allow the user to select and download files by allowing the user to listen to the files or view files presented by the server 206, select a file, and issue a download command to the server 206. The server then sends the selected file (e.g. in digital compressed form), for example, using a Custom Data Transmission Protocol (CDTP), over the voice channel. (illustrated in FIGS. 3 and 13).

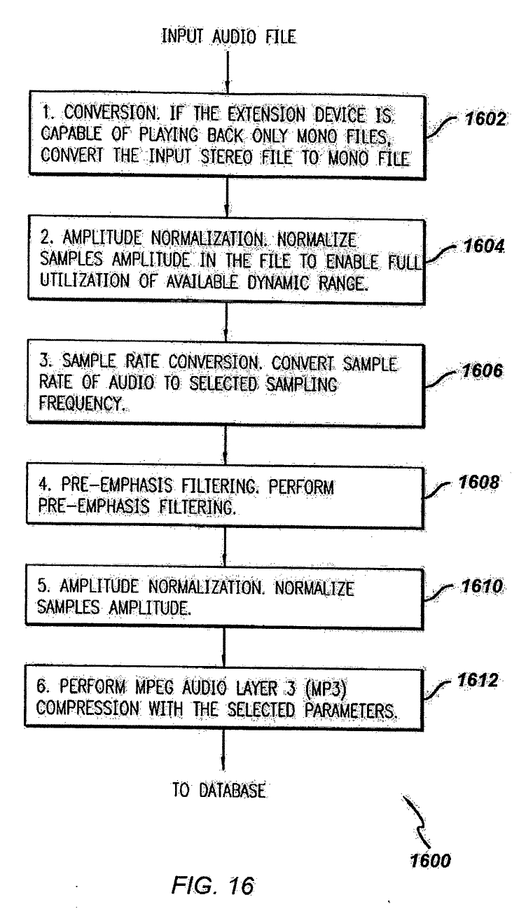

The system 200 allows for storage of a large number of digital audio and/or image files in the chip's memory. The system's server 206 utilizes an audio and/or image compression algorithm, such as a music compression algorithm shown in FIG. 16 which converts common music files into compressed files and/or compresses image files that are downloaded and stored by the chip 206. For example, a chip supporting the storage of about 1000 files, each being approximately a few minutes in length, may have a flash memory size of about 40 Mbytes. The chip 204 may also have a sound output element such as speakers.

Sound or audio compression is a form of data algorithmic compression designed to reduce the size of sound files for space requirements as to storage and the amount of time needed for transmission of compressed files. For example, a typical CD may hold one hour of high fidelity music, or up to seven hours of music compressed algorithmically in MP3 or an equivalent or similar format. Audio compression algorithms are implemented in computer software and are oftentimes referred to audio codecs. Both lossy and lossless compression algorithms are employed in audio compression, where information redundancy used to describe data is reduced. With lossless compression, an exact copy of an audio file may be preserved, as opposed to lossy compression techniques, such as MP3 or Vorbis, where an audio file is irreversibly changed. Lossy compression, however, typically achieves far greater compression than lossless compression, of say 5-20% or the original stream versus 50 to 60% of the original stream. Some lossless formats include for example, Dolby True HD.

As with audio compression, both lossy and lossless compression algorithms are used in image and video compression. Also, in the same manner as audio compression, whether lossy or lossless techniques are used, such as in the present invention, is more or less a preference of the operator or user, or both, depending upon end uses contemplated or personal desires and the like. For example, some may prefer lossless compression for animations, comics, or other artificial images, where in video compression, lossy compression techniques are oftentimes preferred, as much of the data present before compression may not be necessary. For example, DVDs that are compressed by an MPEG-2 coding standard can be compressed from about two hours of video data by up to fifteen to thirty times, while still producing acceptable or what some may consider high-quality, standard definition video. Video image and sound compression, in accordance with the present invention may therefore be accomplished by any of a number of known techniques, and even improved techniques not yet available, considering variables, including but not limited to, storage space available or desired, sound or image/video quality, and the cost decompression and/or playback by an end user in a reasonable time. Examples of some compression formats which may be used herein include, but are not limited to:

### Audio Compression Formats

MPEG-1 Layer III (MP3)—MPEG-1Layer II—MPEG-1 Layer I—AAC—HE-AAC G.711—G.722—G.722.1—G.722.2—G.723—G.723.1—G.726—G.728—G.729—G.729.1—G.729a AC2—Apple Lossless—ATRAC—FLAC—iLBC—Monkey's Audio—u-law—Musepack—Nellymoser—RealAudio—SHN—Speex—Vorbis—WavPack—WMA—TAK

### Image Compression Formats

JPEG—JPEG 2000—lossless JPEG—JBIG—APNG—ICER—MNG—BMP—GIF—ILBM

### Video Compression Formats

MJPEG—MPEG-1, MPEG-2, H.261—H.262—MPEG-4 ASP—MPEG-4/AVC -H.263—H.264—AVS—Blink—Dirac—Indeo—MJPEG—Real Video—Theora—VC-1—VP6—VP7—WMV

Throughout this application, the term “files” is intended to mean sound, audio, image and video content files or inclusively “sound and/or image files”.

The server comprises software, which can run under any conventional of available operating system such, as Windows 98, Windows-NT OS or other suitable system, using a voice modem for communications. Additionally, the system may use a single modem or a pool of several modems.

### Preferred Embodiments for a Telephone System

Examples of telephone systems utilizing the method of the present invention include a cellular phone, which may utilize an analogue (voice-only) system or a digital system, and a conventional landline telephony network. A preferred example of a system for using a cellular network infrastructure is shown in FIG. 3. A preferred embodiment of a schematic diagram of a landline transmission system for a home telephone is shown in FIG. 13.

All described examples assume existence of a server or servers or storage medium preferably dedicated for servicing user requests and providing sound and/or image file data download capabilities. A corresponding chip implementing all required functions is associated with the telephone.

The server may be, for example, a computer running Microsoft Windows or other suitable environment, such as a Pentium-111 PC, Win95/98/NT/2000, 128 Mb RAM, 4 GB HDD. The server may store or be capable of accessing a sound and/or image file database, which may be stored on a website or non-web holding unit. The sound and/or image file database is stored in a compressed file format of those commonly known, such as any compression method effective to compress sound and/or image files for transmission over-the-air, wirelessly, and playback on demand on an electronic device, such as a cell phone.

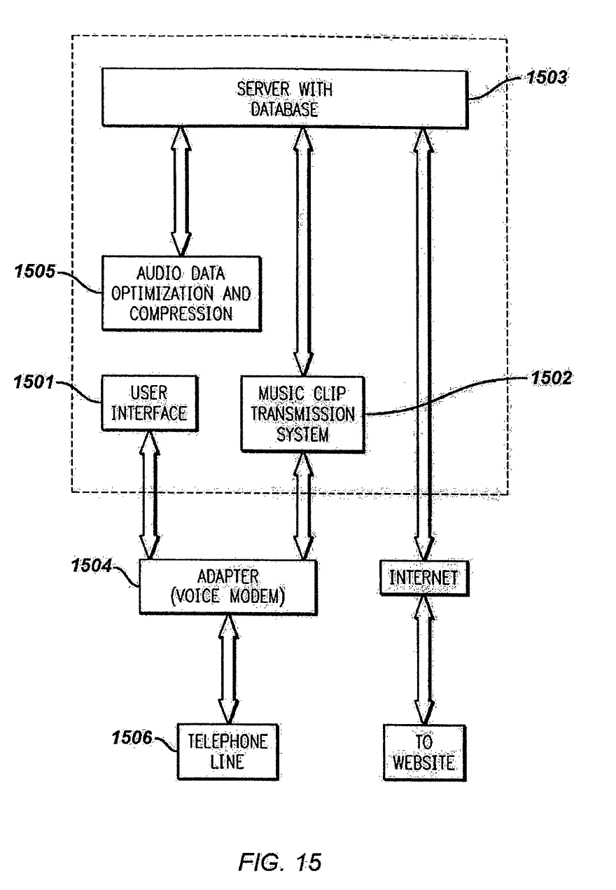

A preferred embodiment of a schematic diagram for a server software system is shown in FIG. 5 for a cellular phone system and FIG. 15 for a landline system. The software may be written in C++ under Microsoft Windows or other suitable effective language. The functions of the server software include servicing user requests via a user interface element and transmitting a selected sound and/or image file through the phone line via a sound and/or image file transmission element.

According to a preferred embodiment, the functions of the user interface element include decoding DTMF keys pressed by the user and playing voice menu labels to the user. The voice menu interface may include hierarchical submenus, leading to different functions. In all examples, the user interface element can be unified in the sense that the voice interface and DTMF or voice recognition-based interface are independent of the type of network or type of phone(s) used. Implementations that utilize a single server to process requests originating from different types of networks and/or phones can therefore be built.

In a preferred embodiment, the system of submenus leads a user to the downloading of selected sound and/or image files. Thereafter, control is transferred to the sound and/or image file transmission element for downloading sound and/or image files into the phone. The sound and/or image file transmission element may interface directly with the phone accessory unit, independent of the user. The sound and/or image file transmission element may be dependent on the type of the phone used and the network infrastructure.

### Example Transmission System for a Cellular Phone and Network

FIG. 3 is a schematic diagram of a preferred embodiment of a wireless transmission system 300 for a cellular phone 302, which may be either an analogue (voice-only) or digital system. In both cases, a specialized board 303, implementing all required functions, similar to the chip 204, is incorporated in an accessory unit 304 attached to the cellular phone. Although the system 300 is described as incorporating an accessory unit, it should be understood that a chip or other transmission receiving and operating functionality performing the same functions of the board for receiving and playing digital sound and/or image files in accordance with the invention may instead be embedded or situated in the phone itself, or a software system may be integrated with the existing hardware chip of a conventional cellular phone without the need for additional hardware. The system 300 further includes a server 306 and software 307 for the server.

The cellular telephone 302 may be any commercially available cellular phone having capabilities for supporting a command set for general telephone control, [e.g., a V.25TeT serial asynchronous automatic dialing and control as recommended by the ITU-T (International Telecommunication Union-Telecommunication sector)] and for supporting V.25Ter “+C” extensions according to the ETSI (European Telecommunications Standards Institute) ETS-300-916 standard for obtaining codes of keys pressed by the user, and preferably for receiving caller ID information. Additionally, the phone 302 preferably has capabilities for subscribing to a cellular provider 308 and more preferably with caller ID service support.

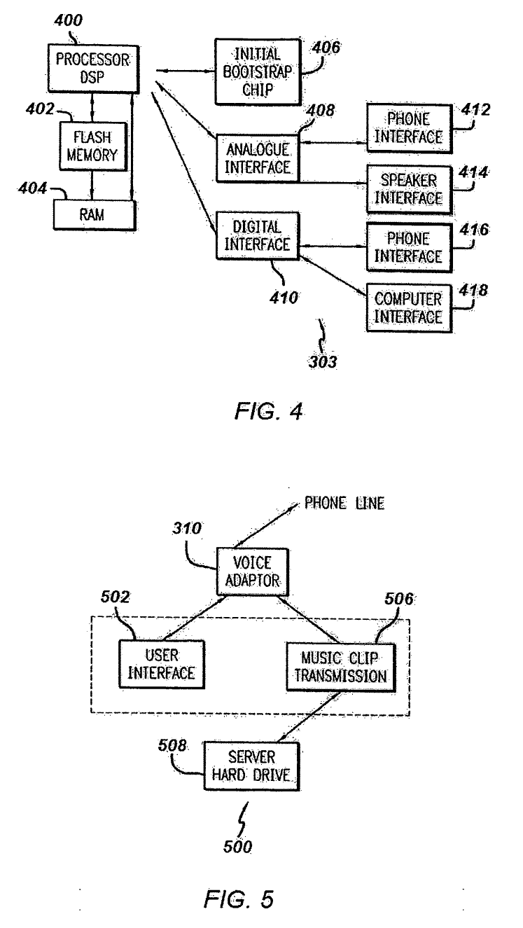

A preferred embodiment of a schematic diagram of the board 303 is shown in FIG. 4. In an embodiment where an accessory unit is used the board 303 is implemented in the accessory unit 304 which can be attached to the phone 302 through a standard extension connector where, for example, other commercially available accessories such as a hands free ear set and charging adapter are typically connected.

The board 303 preferably includes the following main blocks: a Digital Signal Processor (DSP) 400, a flash memory element 402, a Random Access Memory (RAM) element 404, an initial bootstrap chip 406, an analogue interface element 408, and a digital interface element 410.

The processor 400 executes the device firmware, provides control for all other blocks and performs the computational tasks for the board 303. The tasks performed by the processor 400 include control of the board's units, monitoring of keys pressed by the user and processing of key-press events, reception of information from the computer through the computer digital interface, reception of caller ID information through the phone digital interface, reception of compressed or packed sound and/or image files through the phone analogue or digital interface, unpacking and then playing back sound and/or image files through a built-in speaker or phone display, for example, connected to the analogue interface of the accessory unit 304, support of a voice menu-driven user interface, and performance of other auxiliary functions.

The flash memory element 402 contains the device firmware, and sound and/or image files which can be pre-loaded as well as downloaded from the server. The RAM element 404 enables the processor to run faster and also holds buffers for unpacked sound and/or image fragments and processor service procedures. When the power is turned on, the initial bootstrap chip 406 loads the device.

The analogue interface element 408 includes a phone interface element 412 and a built-in speaker interface element 414. The phone interface element 412 is used for input and output of signals when downloading sound and/or image files from the server 306. The speaker interface element 414, with the speaker, plays all system sounds heard by the user including voice menus and sound files.

The digital interface element 410 includes a phone interface element 416 and may include a computer interface element 418. The phone interface element 416 is used for phone control and for receiving key codes and caller ID information from the phone. The computer interface element 418 is used for various service functions such as downloading preprogrammed sound and/or image files from the computer to the flash memory.

The functions of the server software, shown in FIG. 5, include servicing a user's requests via a user interface element 502 and transmitting a selected sound and/or image files through the phone line via a sound and/or image files transmission element 506.

In a preferred embodiment, a user interface element 502 is provided whose functions include decoding DTMF keys pressed by the user and playing the voice menu labels to the user. The voice menu interface may include hierarchical submenus, which lead to the downloading of the selected sound and/or image file. Thereafter, control is transferred to the sound and/or image file transmission element 506 for downloading files into the phone. The file transmission element 506 may interface directly with the phone accessory unit, independent of the user.

In this embodiment, the selected sound and/or image file may be transmitted through the phone line, such as a wireless telephone channel to the accessory unit 304 first through the server hard drive 508, then through the server software 307, next through the voice adapter 310, then through the phone line of the network to the cellular service provider 308, to the cellular phone 302, and through the analogue interface 408 of the accessory unit 304, then through the processor 400 of the accessory unit 304, and finally, through the flash memory element 402 of the accessory unit 304. When the sound and/or image file transmission is completed, the task of the sound and/or image file transmission element is completed. Thereafter, the phone line 504 is released and control is transferred to the user interface element 502.

In an autonomous mode, the board 303 may contain a number of pre-loaded sound and/or image files.

Initially, the board 303 is in the inactive state. The board 303 and phone 302 interact such that the phone sends to the board codes of all the keys pressed by the user. Upon receiving a particular sequence of codes or when, for instance, a particular key is pressed for a prolonged period of time, the board 303 switches to the active mode. In the active mode the board 303 may interact with the user via a voice menu-driven interface where voice messages, via a speaker, prompt the user to respond by pressing a selection of phone keys indicating the user's responsive selections. The board 303 reacts to the user's selections by analyzing the keys being pressed.

The files are preferably stored on an internal file index, which can be retrieved from the internal memory and played back according to key commands provided by the user. Examples of voice menu options provided by the device 304 through a speaker upon switching to an active mode include: 1) the user may choose to exit the active mode and enter the passive mode (e.g., by pressing “0”); 2) the user may choose to listen to and/or view the current sound and/or image file on the file index (e.g., by pressing “1”); 3) the user may choose to listen to or view the next file on the index (e.g., by pressing “2”); 4) the user may choose to listen to or view a previous file on the index (e.g., by pressing “Y’); or 5) the user may choose to assign a caller ID number to the current file on the index (e.g., by pressing “4”).

Upon choosing to assign a caller ID phone number to the current file, the device may switch to a sub mode with a sub-menu having the following options: 1) the user may choose to switch back to the previous menu (e.g., by pressing “0”); 2) if the selected file was already assigned, the user may choose to get information regarding the caller ID already associated with the file (e.g., by pressing “1”); or 3) the user may input a new caller ID phone number for the current file (e.g., by pressing “T′ indicating this choice, then dialing in the phone number followed by the “#” sign).

In a passive mode, the device 304 may analyze messages being received from the telephone 302. Upon receiving an incoming call, the device 304 checks the incoming caller's phone number against the list of assigned caller ID sound and/or image files in its memory and plays back the particular sound and/or image file through the built-in speaker or phone display if the specified caller's phone number was assigned to this file. Alternatively, the device 304 may play back a default sound and/or image file if the particular caller ID was not assigned to any file.

In order to transfer digitally compressed sound and/or image files through the analogue channel in a preferred embodiment, a method and algorithm to map digits to sounds is used. This method is implemented not only for a cellular telephone using an analogue cellular network but also for a landline transmission system of a home phone, shown in FIG. 13.

### Method for Data Transmission Over an Audio Channel of a Wireless Telephone

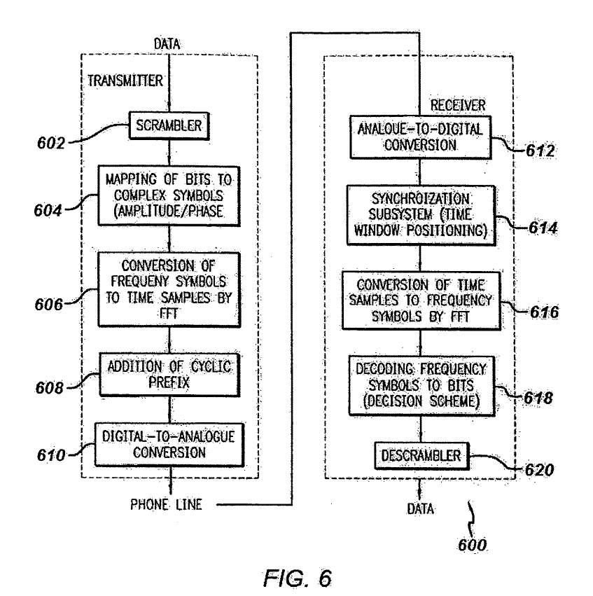

A preferred embodiment of a data transmission method 600 for transferring compressed audio and/or image data through the phone line and the receiver, based on a voice mode connection (versus data mode) and DTMF signal interpretation is illustrated in FIG. 6. A similar approach can be implemented for a landline telephone that does not have a data transmission mode.

For transmitting data through the phone line, the transmission method 600 preferably comprises a) data scrambling 602, b) data mapping 604, c) conversion of frequency symbols to time samples 606, d) addition of cyclic prefix 608, and e) digital to analogue conversion 610. The data is then sent through the receiver, following the reverse steps of f) analogue to digital conversion 612, g) symbol synchronization 614, h) conversion of time samples to frequency symbols 616, i) decoding frequency symbols to bits 618, and j) de-scrambling the data 620.

The transmission method is used to provide enough speed for the data transmission. The preferred transmission method allows simultaneous use of the voice communication and data transmission features (during one connection session) without having to switch the mode of connection. A customer does not need to use a Wireless Internet Service Provider. A user can simply place a regular call to the specific number, e.g., an “800” or other toll-free number, to gain access to a server. The dual mode connection in accordance with the invention allows for voice and “push button” support as well as voice recognition service. Thus, a user does not have to “hang up” a phone after speaking to a line connection to execute key commands in another mode, in accordance with the invention.

An orthogonal frequency-division multiplex (OFDM) modulation scheme may be used for data transmission based on a voice mode connection in a preferred embodiment. However, any of a number of digital modulation techniques may also be used, depending upon the end result contemplated, including, for example, without limitation, amplitude shift key modulation (ASK); frequency shift key modulation (FSK); binary-phase shift key modulation (BPSK); quadrature—phase shift key modulation (QPSK); and quadrature amplitude modulation (QAM) or any other suitable data transmission method. In a preferred embodiment, the benefits of OFDM include: 1) the modulation can be made robust to Inter-Symbol Interference (ISI) by increasing symbol size; 2) the modulation can be made robust to impulse noise by increasing symbol size; 3) for each individual sub-channel, the channel's response could be considered essentially flat, minimizing the need for channel equalization; and 4) different encoding schemes could be used for different sub-channels, for accommodating frequency-selective channel distortions.

The total bandwidth to be used by the method is determined by the worst case of supported audio channel. One example of an algorithm for compression of the voice channel for use herein is the GSM RPE-LTP algorithm which essentially has a built-in down-sampling by a factor of 3 in which the allowed bandwidth is limited at 4000/3=1333 Hz. However, any of a number of conventional algorithms may be used. Usually channel response is severely limited at frequencies below about 200 Hz to 250 Hz. OFDM symbol time-windowing is not required to minimize variations of transmitted signal amplitude envelope.

A compressed voice channel can also introduce significant non-linear distortions. Therefore, it may not be desirable to have a large number of sub-channels; otherwise the algorithm may be affected by significant inter-channel interference (ICI) due to loss of orthogonality between sub-channels. About 32 sub-channels are preferred to provide preferred symbol size while maintaining satisfactory low ICI.

### Modulation Symbol Structure

Preferably each OFDM symbol consists of a minimum number of samples sufficient to represent all sub-channels. To increase computation efficiency, a Fast Fourier Transform is preferably employed to convert sub-channel symbols from frequency to time area. Therefore, for example, for 32 sub-channels, OFDM symbol size should preferably be at least 64 real samples (at 2666 Hz rate). A circular prefix of 16 samples may be used to improve separation between symbols, and minimize ISI (Inter Symbol Interference) and ICI. Therefore, total symbol size is 80 samples at 2666 Hz.

### Receiver Synchronization

In a further preferred embodiment, circular extension prefix redundancy, present in the signal, is used to facilitate OFDM symbol synchronization in the receiver. A synchronization subsystem effectively computes auto-correlation coefficients of the received sequence (e.g., at 2666 Hz). The output of the correlator goes through a “rectifying” phase-locked loop-like system, which outputs synchronization impulses at the proper time instants to sample OFDM, symbols correctly.

Synchronization system induced timing jitter may lead to rotation of received sub-channel phasors by increments, proportional to the central frequency of a particular sub-channel. This rotation is compensated in the decision scheme.

### Data Mapping

In another preferred embodiment, the output of a scrambler is mapped onto complex symbols (amplitude/ phase) of the OFDM sub-channels, Individual sub-channels use QPSK (Quadrature Phase Shift Keying) modulation.

### Data Scrambling

Data scrambling is preferably employed in order to provide statistically random distribution of transmitted symbols to reduce peak-to-average power ratio of OFDM symbols. A self synchronizing scrambler with generating polynomial of 1+X-18+X-23 may be used which, at the transmitter, effectively divides the data sequence by the generating polynomial. The coefficients of the quotients, taken in descending order, form the output data sequence.

Preferred Example Using analogue Cellular Network and Cellular Telephone

The above-described accessory unit 304 is provided in this example in the context of analogue (providing only voice channel) cellular network.

In this preferred embodiment, initially, the device 304 is in an inactive mode. A user dials the server number and, navigating through a system of voice menus supported by the server software, listens to and/or view and selects a particular sound and/or image file in the same way as browsing the loaded files in the autonomous mode. Instead of assigning a caller ID, the user may choose to download files.

When a user, navigating through the server voice menus, selects to download the current file and in the embodiment using an accessory unit activates the accessory unit 304 through the predefined key sequence, the process of transmission of the selected file is initiated. After selecting a “download” option, the user may press a specific key combination on the phone to switch the accessory unit 304 from the inactive to the active mode. The unit 304 then begins to interact with the server 306, using the analogue channel provided by the phone and network. The already established phone connection is used to receive information. The device may receive the file selected by the user and download it into internal flash memory.

At the end of a session, the unit 304 forces the telephone 302 to hang up and switches to the autonomous mode, which enables the user to assign a new caller ID to the file just received. When a user, navigating through the server voice menus, selects to download a file and activates the accessory unit 304 through the pre-defined key sequence, the process for transmission of the selected file is initiated.

The selected file is transmitted through the phone line to the accessory unit 304 first through the server hard drive 508, then through the server software 307, next through the voice adapter 310, then through the phone line of the network to the cellular service provider 308, to the cellular phone 302, and through the analogue interface 408 of the accessory unit 304, then through the processor 400 of the accessory unit 304, and finally, through the flash memory element 402 of the accessory unit 304.

Generally, the server software 307, for example, in the case of a sound file, retrieves the selected file from a database 312, converts it to the special sequence of sounds modulates, transfers codes of these sounds to the voice adapter 310 that converts these codes to actual sounds and transfers these sounds to the phone line 314. From the phone line 314, the sounds go to a cellular provider 308 through to a radio channel, and to the cellular phone 302, itself, much like voice sounds are transferred during a normal phone conversation. The sounds then go through the connector and are received in analogue form by the board 303. The sounds are then converted by the device ADC (Analog to Digital Converter) to the digital form and are processed by the DSP (digital signal processor—“demodulated”) 400 to the same digital data form initially stored on the database 312 (e.g., in MPEG audio format). In this form, the sound clip data are written into the flash memory 402 of the device 304.

Following a reverse direction, going from the board 303 to the server 306 using the same chain, the device sends to the server either an “acknowledgement” of a successful delivery of the sound file data or a list of data blocks received with errors so that these blocks can be present in a second try. In order to transmit digital data through the analogue channel, a similar procedure is used to convert data to sounds and back.

When all data is transferred without errors, the board 303 signals to the server 306 that the call may be disconnected. Thereafter, the server 306 instructs the voice adapter 310 to hang up, freeing the phone line for another client, and the board 303 switches to the autonomous mode, allowing the user to assign a caller ID to the sound file most recently downloaded.

Preferred Example Using digital Cellular Network and Cellular Telephone

The above-described accessory unit 304 is used in this preferred embodiment in the context of digital (capable of providing a dedicated data transmission channel) cellular network. However, as mentioned above, all of the functionality, circuitry, etc., of the attachment may be present in a cell phone manufactured to be thus enabled. Since in this case a digital channel is used for sound and/or image file data transmission, no modulation is required on the mobile phone side. The server, on the other hand, preferably uses a modulation protocol compatible with the protocol supported by the cellular network provider. Usually this can be accomplished by using a standard ITU-T-approved modem, like V.32 or V.34, however, any effective method is contemplated for use herein.

Initially, the unit 304 is in an inactive mode. A user dials the server number and, navigating through a system of voice menus supported by the server software, listens to and/or views, and selects a particular sound and/or image file in the same way as browsing the loaded sound and/or image files in the autonomous mode. Instead of assigning a caller ID, the user may choose to download clips.

When a user, navigating through the server voice menus, selects to download the current file and activates the accessory unit 304 through, for example, a pre-defined key sequence, the process of transmission of the selected sound and/or image file is initiated. After selecting a “download” option, the user may press a specific key combination on the phone to switch the accessory unit 304 from the inactive to the active mode. The unit 304 then begins to interact with the server 306, using the digital channel provided by the phone and the network. If possible, an already established phone connection is used, or a new connection is established specifically for digital data transmission.

In a preferred embodiment, the selected sound and/or image file is transmitted through the phone line to the accessory unit 304 first through the server hard drive 508, then through the server software 307, next through the voice adapter-modem 310, then through the phone line of the network to the cellular service provider 308, to the cellular phone 302, and through the digital interface of the accessory unit 304, then through the processor 400 of the accessory unit 304, and finally, through the flash memory element 402 of the accessory unit 304.

Generally, the server software 307 retrieves the selected sound and/or image file from a database 312 and, for example, in the case of a sound file, transfers codes of these sounds to the voice adapter-modem that converts these codes to actual sounds, using one of the standard modulation protocols supported by the cellular provider (like ITU-T V.32 or V.34) and transfers these sounds to the phone line 314. From the phone line 314, the sounds go to a cellular provider 308, where they are demodulated back into digital data and then the data goes to the cellular phone 302, through the radio channel, using the digital channel provided by the cellular network. The data is then received by the processor of the accessory unit, and then written into the flash memory 402 of the device 304.

Following a reverse direction, going from the board 303 to the server 306 using the same chain, the device may send the server either an “acknowledgement” of a successful delivery of the sound and/or image file data or a list of data blocks received with errors so that these blocks can be resent in a second try. Preferably, when all the data is transferred without errors, the board 303 signals to the server 306 that the call may be disconnected. Thereafter, the server 306 instructs the voice adapter-modem to hang up, freeing the phone line for another client, and the board 303 switches to the autonomous mode, allowing the user, for example, to assign a caller ID to the sound and/or image file most recently downloaded.

In yet another preferred embodiment of the present invention, in order to provide a guaranteed and error-free delivery of digitally compressed sound and/or image file data through the data channel provided by the phone and network, an error detection and correction method may be employed.

A Data Transmission Method with Error Correction Delivery

In this preferred embodiment, a method for data transmission with error correction preferably assumes a sufficiently low probability of error in the channel and implements error correction by re-sending the affected data blocks. The data (e.g., the compressed sound and/or image file) is split into smaller data blocks by the server. Each block is supplied with a special header that, in particular, includes the block number and a cyclic redundancy code word for error detection, computed for the block data and header. Other error detection codes can also be utilized. The data blocks are then sent through the data channel sequentially. Using the redundancy code, the receiver (e.g., the mobile device) checks the correctness of each received block. The size of blocks is preferably selected in such a way that 1) there is a high probability of error-free transmission of a block; and 2) the overhead introduced by additional control information (e.g. header, CRC word) is not high compared to the data payload.

If the block size is selected properly, only a few blocks out of the entire sequence are usually affected by channel errors. These erroneous data blocks may be re-sent by the server upon receiving special requests.

Depending on the availability of bi-directional data transfer, one or more protocols may be used. For example, if the phone and network support simultaneous transmission of data in both directions, a protocol that uses simultaneous transmission of data in a server-to-phone direction and acknowledgements in a phone-to-server direction can be utilized. In this case, a special acknowledgement packet may be preferably sent for each valid data block received by the device. If a block is received with an error, a negative acknowledgement packet may be sent.

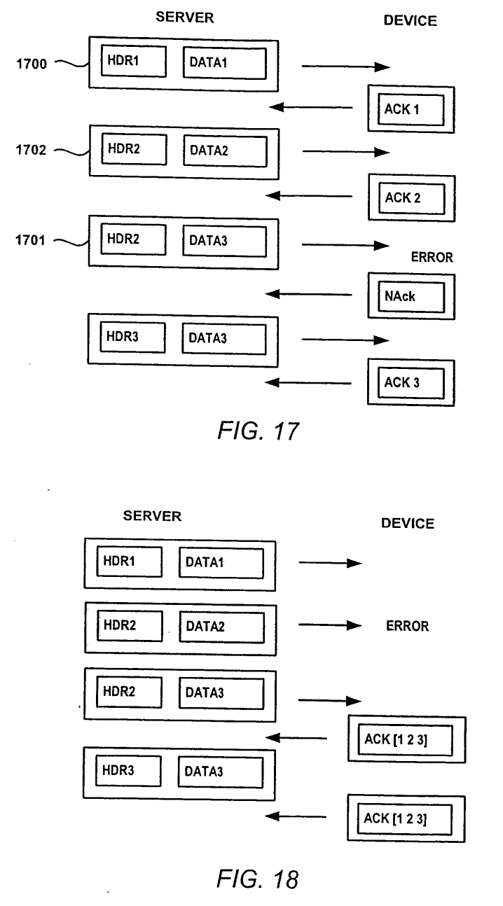

The sever software, receiving these control packets, may either send the next subsequent data block, until all data blocks are transferred, or resend the block received with error. When all data blocks are transferred, and positive acknowledgement is received for the last block, the sound and/or image file is considered to be completely delivered. An example of such interaction is shown in FIG. 17 for a protocol with individual packet acknowledgement for full-duplex channel, showing three data blocks 1700, 1702, and 1701 for corresponding data, indicated in the figure as “Data1”, “Data2” and “Data3”, with corresponding headers “Hdr1”, “Hdr2”, and “Hdr3”. Positive acknowledgements “Ack138 and “Ack2” are sent for packets numbers I and 2. Packet number 3 is originally received with an error, indicated by “Nack” and is subsequently re-sent to successfully correct the error, whereby a positive acknowledgement “Ack3” is sent.

If the phone or network supports only unidirectional data transmission, another protocol can be utilized to minimize the number of channel direction alterations. In this case, all data blocks for the sound and/or image file are sent at once by the server, without receiving acknowledgements for the individual packets. Then, a single control packet is transferred in the opposite (device to server) direction. This control packet contains a bit mask, with one bit for each data block received. Each bit in the bit mask has a “1” value if the corresponding data block was received without errors, or a “0” value if the corresponding block was affected by errors. The server then re-sends those blocks that were received with errors in the first pass. When all data blocks are transferred, and the acknowledgement mask without errors indication is received by the server, the sound and/or image file is considered to be completely delivered. An example of such interaction is shown in FIG. 18, where the packet number 2 is originally received with an error and is successfully resent subsequently to correct the error. Note that only two “ACK” packets were sent during the entire procedure.

### Preferred Example Using Landline Telephony Network and a Conventional Home Telephone

FIG. 13 illustrates in yet another preferred embodiment, an example of a landline telephony network system 1300 using a voice channel and a conventional home telephone 1301. Although this system is described with respect to the accessing and delivery of sound and/or image clip, it is to be understood that the system may be used for the accessing and delivery of entire files.

The system 1300 has two main components: a home telephone accessory unit 1302 and a server 1305. The accessory unit 1302 is an autonomous unit, attached to the phone line 1308 and to the phone (between the line and the phone), and powered from the AC power outlet. A chip or other effective circuitry and functionality performing the same function of the accessory unit may instead be embedded, or manufactured in the phone itself. The purpose of the accessory unit 1302 is to support selection, downloading, and playback of sound and/or image files according to the Caller ID of the calling subscriber. As in the case of image files, a landline telephone device is enabled with a visual image display. The accessory unit 1302 may include a speaker system and enables the phone to “ring” sound and/or image files or perform other functions as described for the cellular phone 202.

The server 1305, which is associated with stored files 1306, which may be stored on a website or a non web holding unit, is designed to execute requests of the accessory unit 1302 either through user voice commands or commands using the phone keys, and allows for files to be transmitted to the accessory unit 1302 for storage. The system 1300 enables a connection to the server upon a request from the accessory unit 1302, utilizing the phone and PSTN (Public Switched Telephone Network), and an adapter 1304 (voice modem) attached to the server computer. The system 1300 may have a voice menu, which, after connection to the server, allows the user to listen to and/or view the server's menu and navigate through the system of voice menus using the phone's DTMF keys. The system may allow the user to select and download files by allowing the user to listen to the files presented by the server, select a file, and issue a download command to the server. The server then sends the selected file, in compressed format, for example, using the Custom Data Transmission Protocol (CDTP), over the voice channel.

The device 1302 may further interface with a home PC 1314 for downloading sound and/or image files to the device. The interface may be a plug in connection or may use a wireless network system.

The accessory unit 1302 may be sold as a unit compatible to most home phones including cordless phones, and may connect directly to the phone jack, with the phone connected to the device. Similar to the cellular phone 202, a home phone may include an embedded chip, instead of the accessory unit 1302, for performing functions similar to those of the accessory unit 1302.

The handset of a cordless phone utilizing sound and/or image files according to the present invention may ring simultaneously with the box, for example, wherein the handset may sound a regular phone ring or a sound clip and/or image file while the box plays a sound and/or image file ring.

The server comprises software shown in FIG. 15, which can use any suitable operating system, such as Windows 98®, Windows-NT OS®, or other suitable system using a voice modem for communications. Additionally, the system may use a single modem or a pool of several modems. Initially, the accessory unit 1302 is in an inactive mode. A user dials the server number and, navigating through a system of voice menus supported by the server software, listens to and/or views, selects a particular sound and/or image file in the same way as browsing the loaded sound and/or image files in the autonomous mode. Instead of assigning a caller ID, the user may choose to download sound and/or image files.

When a user navigating through the server voice menus selects to download the current file and activates the accessory unit 1302 through the pre-defined key sequence, the process of transmission of the selected sound and/or image file is initiated. After selecting a “download” option, the user may press a specific key combination on the phone to switch the accessory unit 1302 from the inactive to the active mode. The device 1302 then begins to interact with the server 1305, using the analogue channel provided by the telephone and the network. An already established phone connection is preferably used to receive information.

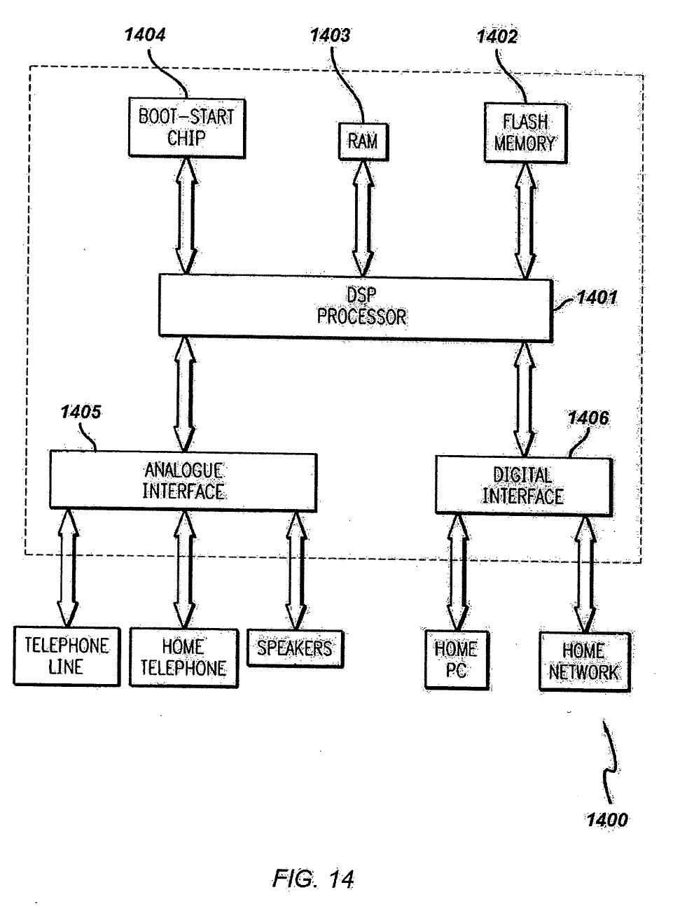

The selected sound and/or image file is transmitted through the telephone line to the accessory unit 1302 first through server 1305, next through the adapter 1304, then through the telephone line of the PSTN to and through the analogue interface 1405 of the accessory unit (shown in FIG. 14), then through the processor 1401 of the accessory unit 1302, and finally, through the flash memory element 1402 of the accessory unit 1302.

A preferred embodiment of a schematic diagram of a board 1400 implemented in the accessory unit 1302 is shown in FIG. 14. The board preferably includes the following main blocks: a processor element 1401 [e.g., a Digital Signal Processor (DSP)], a flash memory element 1402, a Random Access Memory (RAM) element 1403, a bootstrap chip 1404, an analogue interface element 1405, and a digital interface element 1406.

The processor 1401 executes the device firmware, provides control for all other blocks and performs the computational tasks for the board. The tasks performed by the processor 1401 may include: control of the board's units, monitoring of keys pressed by the user and processing of key-press events, reception of information from the computer through the computer digital interface, reception of caller ID information from telephony service provider, reception of sound and/or image files through the phone analogue interface, unpacking and then playing back sound and/or image files through a built-in speaker or via visual display connected to the analogue interface of the accessory unit 1302, support of a voice menu-driven user interface, and performance of other auxiliary functions.

The flash memory element 1402 contains the device firmware, and sound and/or image files which can be pre-loaded as well as downloaded from the server. The RAM element 1403 enables the processor to run faster and also holds buffers for unpacked sound and/or image fragments and processor service procedures. When the power is turned on, the bootstrap chip 1404 loads the device.

The Analogue Interface element 1405 includes a telephone interface element and a built-in speaker interface element. The telephone interface element is used for input and output of signals when downloading sound clips from the server 1305. The speaker interface element with the speakers plays all system sounds heard by the user including voice menus and sound clips.

The digital interface element 1406 may include a computer interface element and other digital interface elements to the home network. The computer interface element may be used for various service functions such as downloading preprogrammed sound and/or image files from the computer to the Flash Memory.

In an autonomous mode, the accessory unit 1302 may preferably contain a number of pre-loaded sound and/or image files. Initially, the accessory unit is in the inactive state. The accessory unit 1302 and telephone 1301 interact such that the telephone 1301 sends to the accessory unit 1302 codes of all the keys pressed by the user. Upon receiving a particular sequence of codes or when, for instance, a particular key is pressed for a prolonged period of time, the accessory unit 1302 switches to the active mode. In the active mode, the accessory unit 1302 may interact with the user via a voice menu-driven interface where voice messages, via a speaker, prompt the user to respond by pressing a selection of phone keys indicating the user's responsive selections. The accessory unit 1302 reacts to the user's selections by analyzing the keys being pressed.

In the passive mode, the accessory unit 1302 may analyze messages being received from the telephone 1301. Upon receiving an incoming call, the accessory unit 1302 checks the incoming caller's phone number against the list of assigned caller ID sound and/or image files in its memory and plays back the sound and/or image file, for example, through the built-in speakers or a phone display if the specified caller's phone number was assigned to this file. Alternatively, the accessory unit 1302 may play back a default sound and/or image file if the particular Caller ID was not assigned to any file.

A preferred embodiment of a schematic diagram of the server software is shown in FIG. 15. The server software is used for servicing user requests through user interface element 1501, and transmitting the selected sound and/or image file through the phone line via file transmission element 1502. The user interface element 1501 decodes DTMF keys pressed by the user, and plays voice menu labels to the user. The voice menu interface includes hierarchical submenus to lead the user to the downloading of the desired sound and/or image file, where control is transferred to the file transmission element 1502.

The transmission element 1502 downloads sound and/or image files to the phone, independent of the user interface element, interfacing directly with the phone accessory unit. The transmission element 1502 initially transmits the selected file to the adapter 1504 for data transmission from the server to the accessory Unit. When the sound and/or image file transmission is completed, the task of the transmission element is done, and the telephone line is released and control is transferred to the user interface element 1501.

Generally, the server software retrieves the selected sound and/or image file from a server database 1503, which is preferably associated with an audio and/or visual data optimization and compression element 1505, converts the file, for example, in the case of a sound file, to a sequence of sounds modulates, and transfers codes of these sounds to the adapter 1504 which converts these codes to actual sounds and transfers these sounds to the phone line 1506. From the phone line 1506, the sounds go through the PSTN and are received in analogue form by the accessory unit 1302. The sounds are then converted by the device ADC (Analog to Digital Converter) to the digital form and are processed by the DSP (digital signal processor) 1401 to the same digital data form initially stored in the server database 1503 (e.g., in MPEG audio format). In this form, the sound file data are written into the flash Memory 1402 of the accessory unit 1302.

Following a reverse direction, going from the accessory unit 1302 to the server 1305 using the same chain, the device may in a preferred embodiment send to the server either an “acknowledgement” of a successful delivery of the sound and/or image file data or a list of data blocks received with errors so that these blocks can be resent in a second try. In order to transmit digital data through the analogue channel, a similar procedure is used to convert data to sounds and/or images and back. When all the data is transferred without errors, the accessory unit 1302 signals to the server 1305 that the call may be disconnected. Thereafter, the server 1305 instructs the adapter 1304 to hang up, freeing the phone line for another client, and the accessory unit 1302 switches to the autonomous mode, allowing the user to assign a Caller ID to the sound and/or image file most recently downloaded.

The server audio data optimization and compression element 1305, utilizes a sound and/or image file compression algorithm outlined in FIG. 16, which converts common sound and/or image files into compressed files in order to reduce the file size for minimizing download time, while maintaining predetermined or otherwise desired audio and/or visual quality. These files are downloaded and stored by the accessory unit 1302, again, all of which functionality may be pre-built into a phone or other electronic device.

### Preferred Procedure for Audio Data Parametric Optimization and Compression

The method 1600 of compressing the files preferably comprises a) conversion 1602; b) amplitude normalization 1604; c) sample rate conversion 1606; d) pre-emphasis filtering 1608; e) amplitude normalization 1610; and f) performance of MPEG audio layer 3 (MP3 or other compression protocol) compressions with the selected parameters. 1612. The compressed files are then transferred to the server database.

Step 1602 of conversion to mono only needs to be performed if the input file is in stereo and if the audio output subsystem of the target hardware is only capable of playing back mono audio. At this step all available information is included into the output audio by summing of the left and right channels to form a single mono output.

After conversion, or if the file does not need to be converted to mono, compression preferably begins with the step 1604 of amplitude normalization, wherein sample amplitudes in the file are normalized. This step is preferred for enabling audio utilization of all available dynamic range and for improving the computational accuracy of subsequent steps. In order to maximize preservation of original audio range, a fixed coefficient for the entire audio file normalization may be used. The coefficient is obtained using input file analysis to “stretch” the input audio range over the maximum available range.

Step 1606 converts sample rate of sound and/or image files to selected sampling frequency. The original sound and/or image files may have various sampling rates (44100 Hz, 48000 Hz, 22050 Hz, 11025 Hz, etc.). After analysis of available hardware capabilities an optimal sampling frequency, which provides the most adequate sound and/or image quality, is selected. Increasing the sampling frequency above the optimal sampling frequency would not significantly increase the perceptual sound and/or image quality, due to the limitations of the audio and/or image output subsystem of the accessory unit. For example, for the cellular phone system of FIG. 3, after analysis of available hardware capabilities and a series of perceptual tests, the 22050 Hz sampling frequency was selected as providing the most adequate sound quality since the audio output subsystem of the accessory unit has a relatively sharp drop in response for frequencies above 10-12 kHz.

In another preferred embodiment, in order to avoid aliening effects when changing from higher to lower sampling rate, a low-pass pre-filtering with a cutoff slightly lower than the new Nyquist frequency may be applied before down sampling. For rates that are not multiples of each other, cascaded sampling rate conversion schemes may be constructed to minimize memory consumption and improve performance.

Preferably the step 1608 of pre-emphasis filtering, along with the re-sampling of the previous stage, takes into account the specifics of the audio and/or image output subsystem of the accessory unit, to achieve improvement of the perceptual audio and/or image quality, and to reduce the resulting audio and/or image size after compression.

Since the speaker of the audio output subsystem of accessory unit is preferably very small, the resulting sound has very low power in the low frequency range. Therefore, providing output in the low frequency range may be not preferred, as it would only increase the size of audio file without any perceptual improvements. Additionally, providing output in the low frequency range may create undesirable “overflow” effects for the speaker.

For example, for the cellular phone system of FIG. 3, all frequency content below about 400 Hz is removed from the audio. In order to make the audio more “perceptually rich” in the low-frequency range, frequencies around 600 Hz maybe increased by about +6 dB. The frequency range from 1200 Hz to 8200 Hz is kept unchanged. Then, starting from about 8200 Hz the signal power is gradually increased, up to +15 dB at the highest frequency (11 kHz). This compensates for the drop in speaker transfer function at high frequencies and improves the listening experience.

A set of subjective audio perceptual tests with various types of audio contents, using the wide spectrum of hardware of the target platform has proved that the above-described preferred pre-emphasis desirably improves the perceptual quality of resulting audio. At the same time, reducing frequency contents in the “non-significant” frequency regions allows reduction of the resulting compressed audio size, since the data bits are not allocated to non-used frequencies.

The described preferred pre-emphasis procedure can be implemented in a preferred embodiment by a filtering with a FIR (Finite Impulse Response) filter, according to the formula:

$${y}_{k} = {\sum }_{i = 0}^{N - 1} {b}_{i} \cdot {x}_{k - i}$$

where b, are filter coefficients,

xₖ is the k-th output audio sample,

yₖ is the k-th output audio sample.

The bᵢ coefficients are fixed and computed for the particular sampling rate and the desired pre-emphasis response curve. The filter can be designed to have a linear phase response (this is actually substantially guaranteed if the bᵢ coefficients are symmetric), which would ensure absence of phase distortions to the audio. Since the delay introduced by tile filter is not harmful for off-line processing, the filter size can be made rather large to approximate the desired response curve with a high precision.

In a further preferred embodiment of the present invention, after completing the step of pre-emphasis filtering, normalization of the sample amplitude maybe once again performed. Since the filtering may substantially significantly change the signal, the second amplitude normalization step 1610 is desired to convert resulting audio “loudness” to some predefined value.

Audio code works at approximately 22 kHz sampling rate (both channels). The Mode Control transistor selects the phone interface mode: either RS-232 control mode (closed state) or “hands free” mode (opened state).

From the PC sides CTS and DTR signals are supported. From the phone side CTS and RTS signals are supported, with inverted polarities. For both channels hardware flow control is employed. Analogue signal level at the phone input is about 100 mV RMS. Level at the phone output is about 600 mV RMS.

Proceeding to step 1612, in this preferred embodiment, the processed sound and/or image file may be compressed by either lossy and lossless compression, such as sound into an MPEG, MPEG Layer 3 bit stream, or JPEG formatted file. The resulting bit rate (level of compression) can be varied to suit different needs. For instance, it can be made dependent on the source audio and/or image file length to make the compressed file fit into a pre-defined size. Alternatively, it can be made dependent on the anticipated delivery method to create, for instance, a “built-in” audio and/or image file of a desired quality, or to make the audio and/or image file of a very small size, for delivery through a slow channel. The compression parameters can also be selected so that the clip delivery time is a constant independent of the actual link transfer rate.

### Technical Description of a Preferred Embodiment for a Cellular Phone Accessory Unit

Electrical Schematics

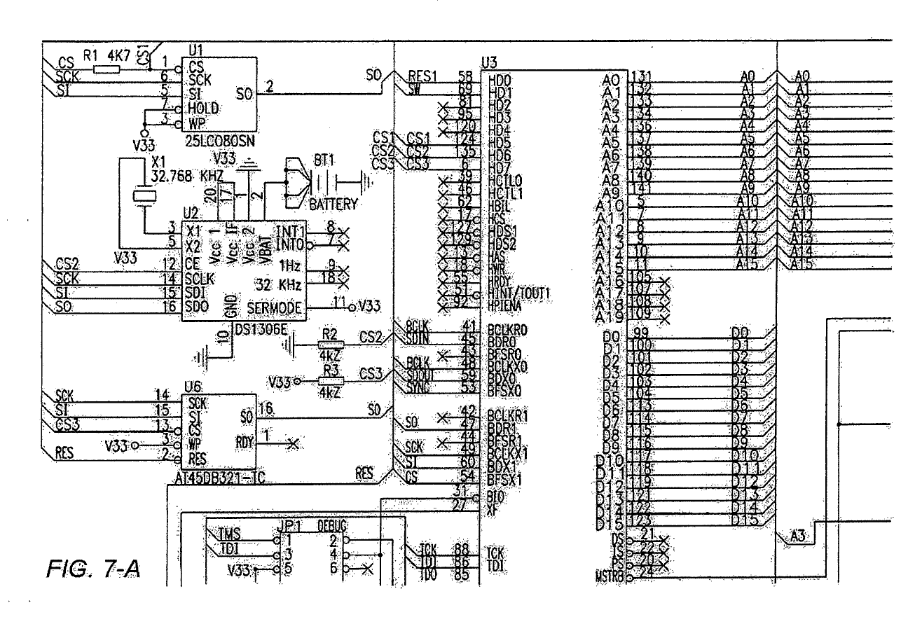

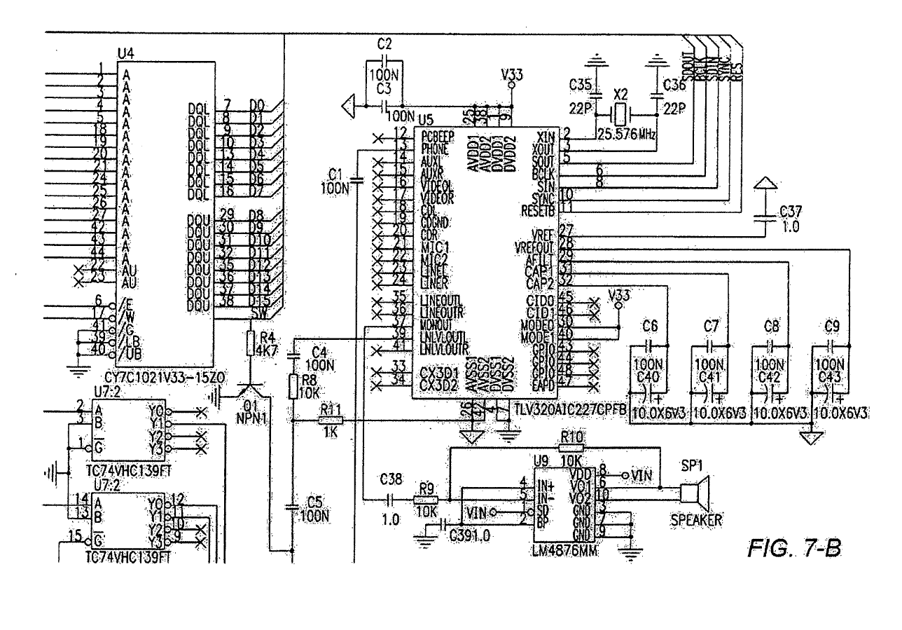

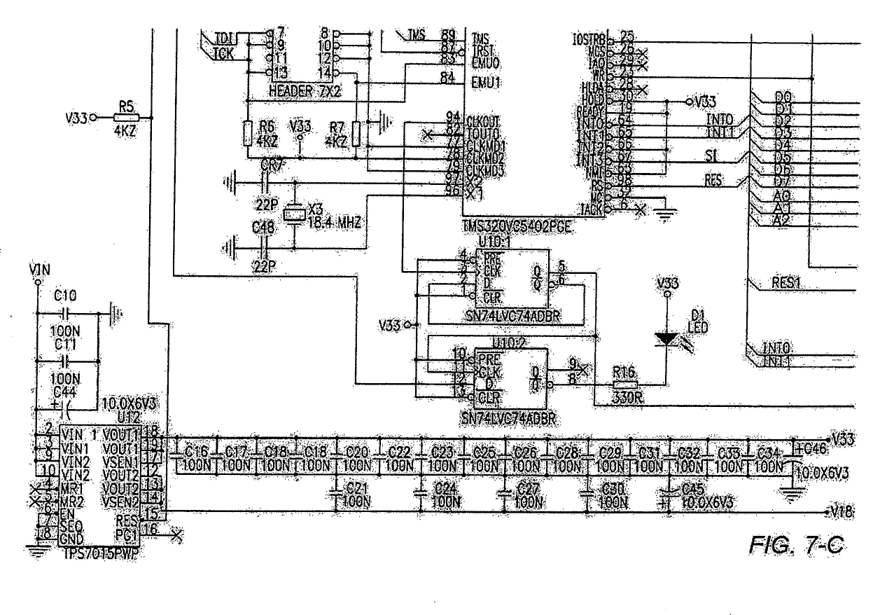

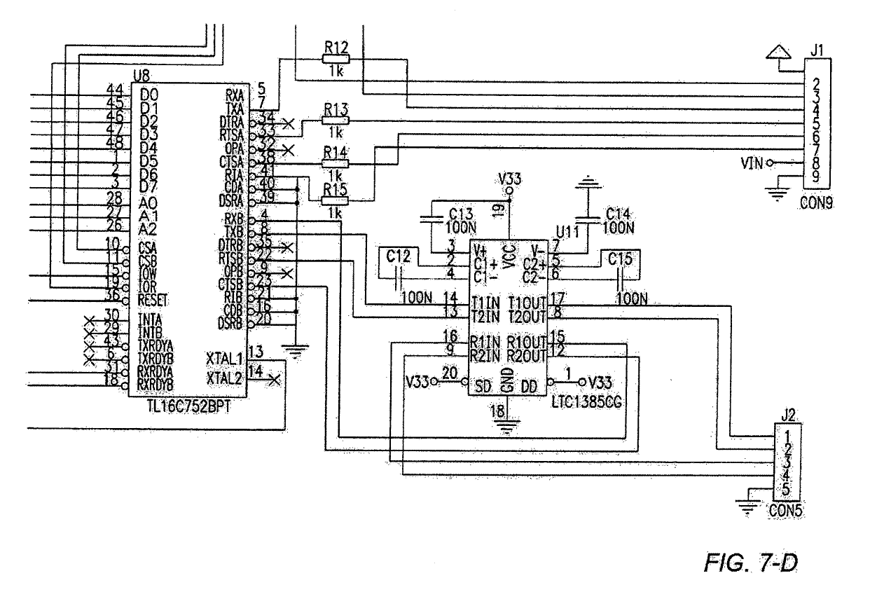

FIGS. 7A-D illustrate by example in a preferred embodiment, the electrical schematics of a mobile phone accessory unit which may alternatively be integrated into a cell phone's construction. The image of the printed circuit board, as rendered by Computer Aid Design Software is shown in FIG. 8. In this exemplified embodiment, initial boot-up of the Processor is done from the EEPROM (Electrically Erasable Programmable Read Only Memory) using passive serial SPI (Serial Programming Interface) protocol. Thereafter, the boot loader code, read from the EEPROM, loads the main firmware from the Flash memory. The PLL (Phase Locked Loop) of the processor is programmed for 5x multiplication of clock frequency.

Firmware debugging may be carried out through the JTAG (Joint Test Action Group) port using standard TI (Texas Instruments) software. External RAM can be mapped both to the program and data space at the same addresses and occupies all lower address space (64 k). Flash memory (Serial Data Flash) can be accessed using software emulation of SPI protocol.

Audio code (Coder-decoder) works at approx. 22 kHz sampling rate (both channels). The Mode Control transistor selects the phone interface mode: either RS-232 control mode (closed state) or “hands free” mode (opened state).

Both channels of RS-232 work at 11,520 baud rate. From the PC side CTS (Clear to Send) and DTR (Data Terminal Ready) signals are supported, with inverted polarities. From the phone side CTS and RTS (Request to Send) signals are supported, with inverted polarities. Both channels employ hardware flow control.

The analogue signal level at the phone input is about 100 mV RMS (Root Mean Square). The level at the phone output is about 600 mV RMS.

### Content Optimizaiton and Adaption

The terms, “optimization” and “adaptation” are used interchangeably herein, and include a process of selection, generation or modification of content (text, images, audio and video) to suit an operator or user of the inventive methods and system and/or, for example, a particular user's wireless electronic device, such as a cell phone or PDA, and usage context. Such optimization/adaptation can be applied to transformations within media types, such as reducing image size or resolution, and across media types, such as converting speech to text, or video items to image montage.

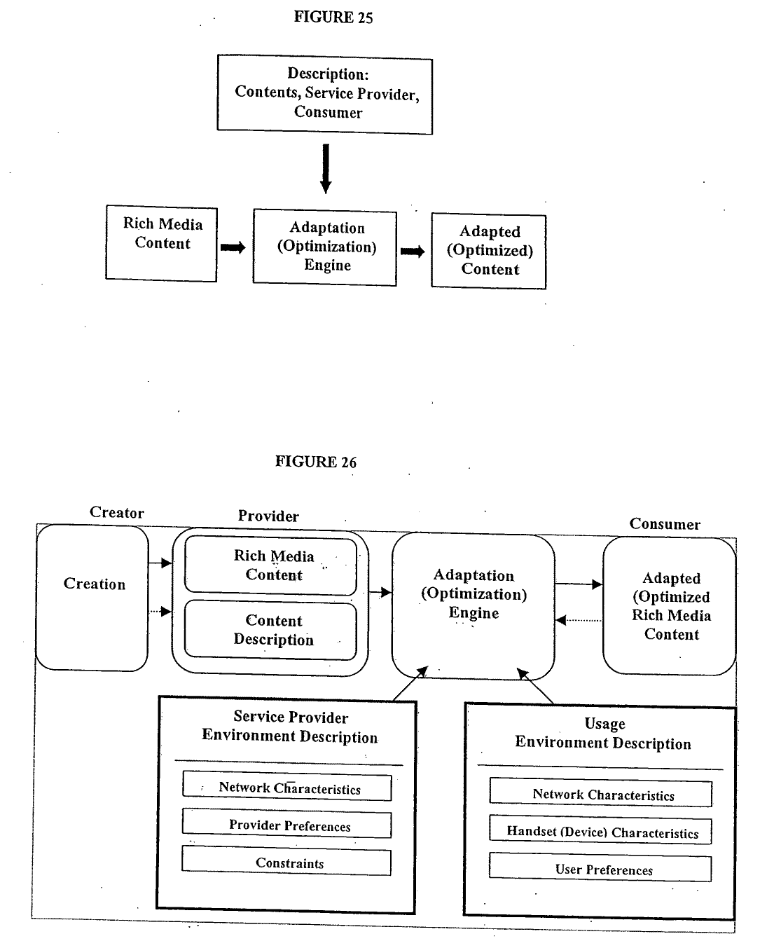

An preferred example schematic is set forth in FIG. 25.

In general, without limitation, when accessing a service with a mobile phone, for example, an image is rescaled and compressed. Text is summarized and video content is delivered as text or an image set, depending on available bandwidth. Oftentimes, for a cellular phone user only the header is shown on the screen.

Content Optimization and Adaptation for Mobile Phones based on User Profile Specification Developed by the Open Mobile Alliance (OMA, former WAP Forum)

An additional preferred example schematic of content optimization/adaptation in accordance with the invention set forth in FIG. 26.

This example depicts a concrete vocabulary dedicated to mobile phone description and defines an efficient transmission of the descriptions over wireless networks. Information may cover such attributes of an electronic device employed, without limitation, the hardware platform, for example, screen size, audio capability, color capability; a software platform, for example, the operating system, mime types, character sets, transfer encodings, audio and video encoders supported; network characteristics, GSM/GPRS, for example, capability, security support, Bluetooth support; browser characteristics, for example, browser info, HTML/XHTML, Java, JavaScript, frames and tables capability; WAP characteristics, for example, WAP/WML support, deck size, and push characteristics, for example, push content types, push message size. As shown in the example schematic, adaptation (optimization) of rich media content, e.g., sound and/or images, including video, may have certain considerations from a service provider's prospective, including, but not limited to, network characteristics, provider preferences, and constraints, and certain considerations from a usage perspective, such as, but not limited to, again, network characteristics, handset (electronic device) characteristics, and user preferences.

Cellular Phone with Accessory Unit

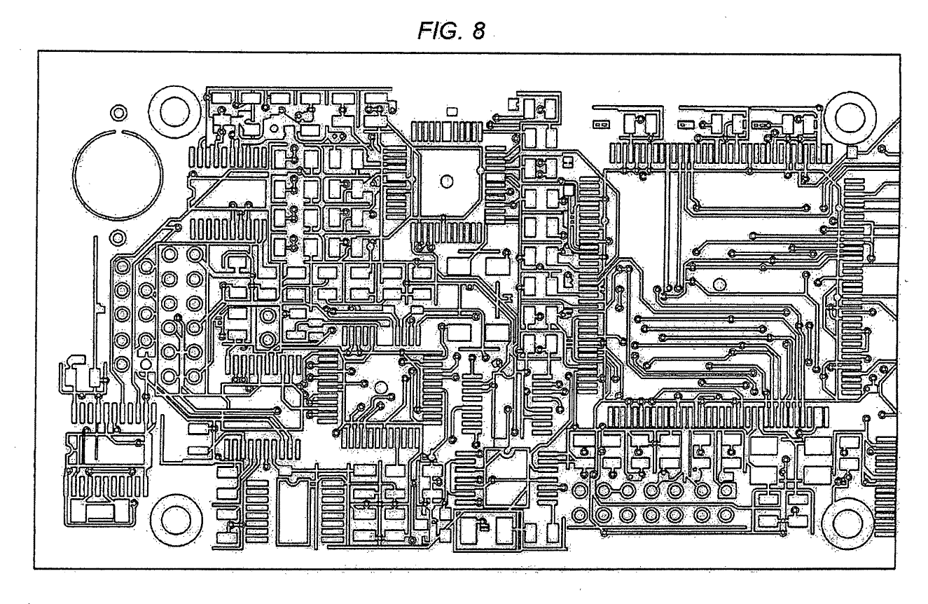

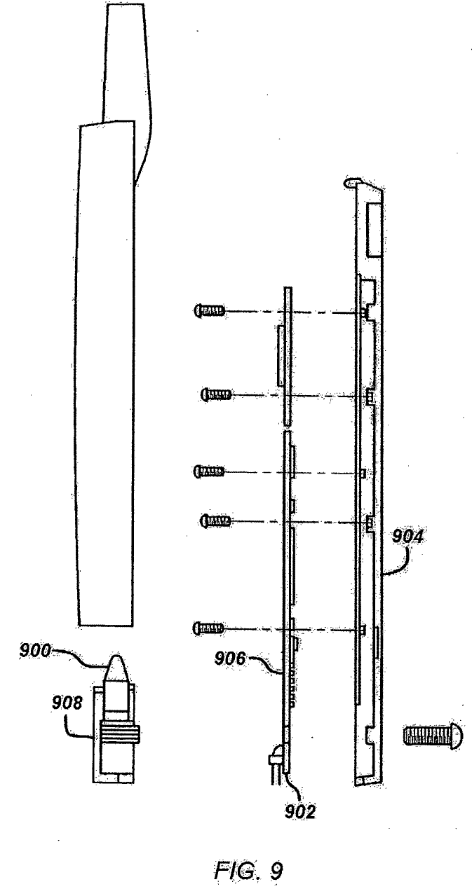

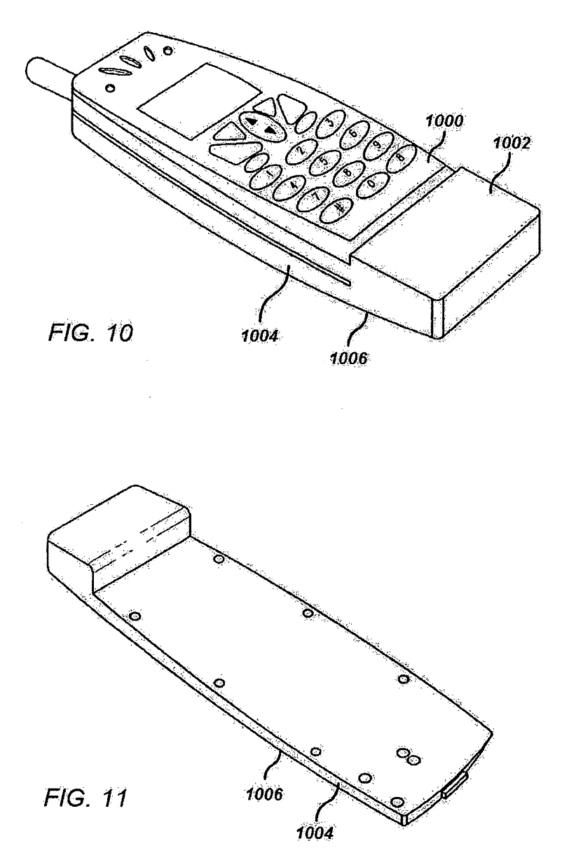

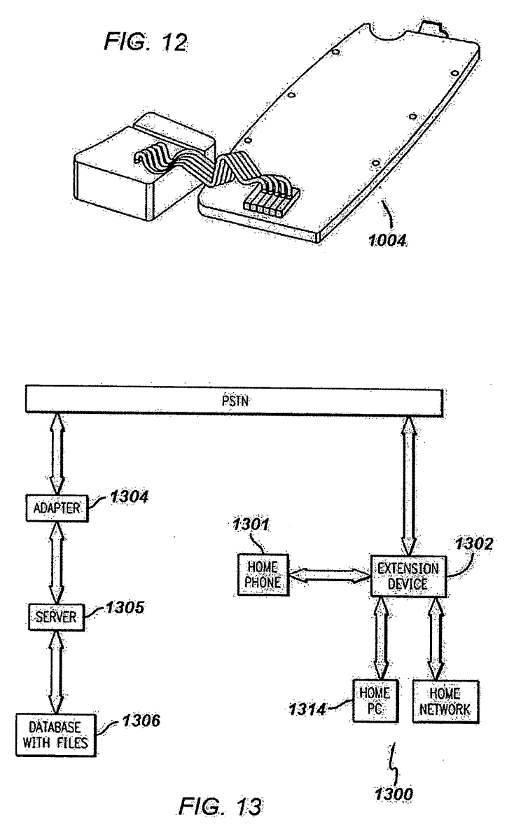

A cellular phone 1000 with an accessory unit 1002, according to another preferred embodiment, is shown in FIGS. 9 and 10 using an Ericsson R520 cell phone as an example. The accessory unit is housed in thin cover 1004 (see FIGS. 11 and 12) providing a mounting body 1006 for attaching the phone 1000 to the unit, via an interface connector 900. The accessory unit contains the printed circuit board 902 and speaker, preferably along the thin portion of the body.

The accessory unit is attached to the back of the phone using the phone connector 900. A snap mounting which utilizes a dimpled section on the phone case typically intended for a car phone holder may also be used.

The accessory unit includes the server software and two voice modems, attached to the server. The mounting body contains all necessary electronic components.

The tasks of the electronic components include playing back of a pre-loaded sound file upon a caller ID notification reception and downloading new files from the server.

The body of the accessory unit preferably comprises a base 904, a thin cover 906, and a molded cover 908. All three-body components are preferably made of high-quality aluminum-magnesium-copper alloy (duralumin) and are chemically covered with a protective oxide film using two different dyes (colored and black) for the two copies of the device. A dense rubber casing may also be used. Factors considered in selecting the body material include lightness (so that the accessory unit would not exceed the phone itself in weight), mechanical strength, and the quality of electromagnetic shielding properties for protecting the internal components from the waves radiated by the phone.

According to one embodiment, the accessory unit that embodies the delivery system for a cellular phone attachment is about 1.5″×1.5″×0.25″ and includes a small high fidelity built-in speaker. The accessory unit may connect into the AC adapter fixture in the bottom of a cellular phone. A dense rubber casing or glove may house the device to protect it. The inside of the rubber glove may have a molded cavity that the device will fit into. The glove may have a circle of small holes, which line up with the device's speaker to allow full sound penetration. The device and glove may be sold in different design variations both for marketing purposes and for fitting the different cellular phones on the market.

Additionally, the accessory unit may connect into a cable connector instead of an AC adapter jack so that different jacks can be used. The device may also be modified with four or five variations to fit the various cellular phone software systems, (not AC adapter variations) currently on the market. The device, including a speaker, may also be made with several different adapter applications that would attach to a variety of different phones.

A snap-on mount for fastening the accessory unit to the phone may be located in the base body. The main purpose of the thin cover is to provide the electromagnetic shielding. The molded cover 908 contains connectors and some other components.

A simple snap mechanism for attaching the accessory unit to the phone, similar to the installation of a cellular phone to a car phone holder, may be provided.

FIG. 11 shows the accessory unit by itself, detached from the phone. The accessory unit can be detached from the phone similar to the detachment of other accessories such as the phone charger (usually by applying a rotating force rather than pulling straight out).

FIG. 12 shows the accessory unit uncovered. It is preferable to leave the body of the accessory unit closed. Preferably, there are no glued, soldered, or other permanent junctions inside, however, the high precision in the manufacture of some components could lead to their degradation after repeated assembly and disassembly.

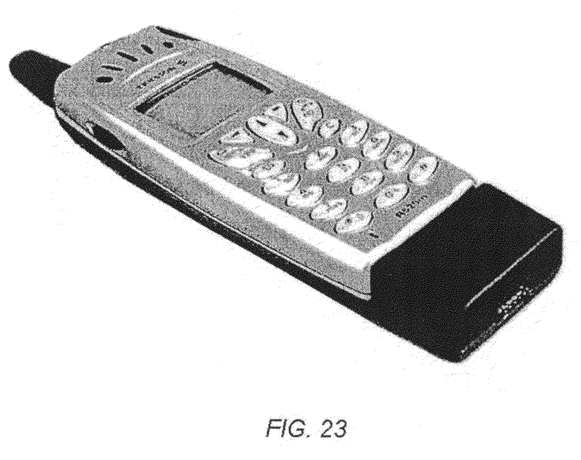

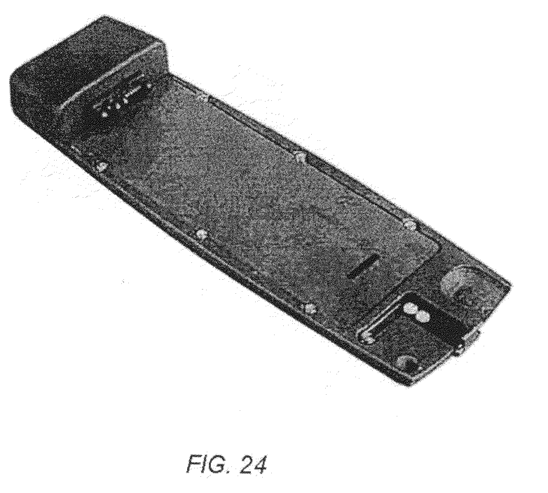

FIGS. 23 and 24 show an electronic device that may be culpable to another device or system to provide the capabilities described above. The device or system may not have the capabilities to accomplish the methods described in exemplary embodiments described herein. The “fish tail” design may be more attractive to users. Furthermore this device may be made of plastics, metals, and other materials, or combinations thereof.

The accessory-to-phone mounting is preferably designed to withstand repeated attachment and detachment without degradation of the snap-on mounting or connector. Although the phone body is also durable, it is preferable to attach and detach the accessory by shifting the snap-on lock upward manually during the attachment procedure (like during detachment) to reduce wear of phone body near the latch.

The PCB (printed circuit board), located inside the accessory unit, is a multi-layer board, which may have 0.2 mm gaps, multi-solder mask layers, and a silkscreen layer. The board preferably carries all the components, as illustrated in the schematics, excluding connectors and the speaker. Two outer layers of the board are signal layers; two internal layers are ground and 3.3V power plane. For convenience of the PCB assembly on modem plants, most packages are surface-mounted but not BGA.

The phone connector is preferably selected to maximize the firmness of the attachment, taking into account significant dimensions of the accessory unit. It should be mentioned that the connectors may be unique to the type of the phone used (Ericsson R520 and compatible, like R320 and T28, in this example).

Factors in selection of the speaker for music playback include sound quality, which is primarily related to the speaker size, compactness, and weight of the speaker, as it is desirable that the speaker not be thicker and heavier than the phone itself. Depending on the available technology, there may be some tradeoff between good speaker quality and having a lightweight speaker. Speakers used in professional radio receivers-scanners may be a reasonable compromise since such speakers provide better than usual sound quality while possessing reasonable dimensions and weight. Other options include either sacrificing weight and dimensions to increase sound quality or using so-called “ceramic” speakers. Mention should be made that although using these speakers could provide better quality, special modifications to the device may be required since these speakers may not be directly substituted in place of the standard ones.

It should also be noted that the bandwidth of the acoustic channel of the cellular phone which, in turn, is non-linearly compressed and transmitted over a digital channel of the phone, is much less than the bandwidth of the conventional landline phone and can deliver about 150 bytes per seconds data transfer rate. Conventional landline phones can deliver about 3700 bytes per seconds (V.34). Using better speakers in the phone would entail loading sound fragments of better quality (and, therefore, of bigger size), which would increase the time, for example, necessary to download a melody. The problem could be solved by using the GSM digital data channel directly which would provide a rate of about 1000 bytes per second for existing cellular networks and more than 7000 bytes per second for newly deployed systems. Alternative solutions include, for example, having to tolerate an increase in the sound file or sound clip download time, downloading a melody from a local computer (the melody being delivered to the local computer by some alternate means), and redesigning the system to support conventional (landline) phones. In the latter case, due to the significant increase in the device body size, it may make more sense to use a stereo-effect (which is reasonable when the speakers of left and tight channels have enough spatial separation).

### Server Software Description

In a preferred embodiment, the server described herein performs the following functions: 1) startup, detection of the modem, detection of the sound and/or image files available; 2) answering incoming calls; and 3) servicing requests of user via DTMF codes. Upon startup, the application requests the user to select which device to work with. Possible options include local test mode (0), modem on COM1 port (1), and modem on OM2 port (2).

If the local test mode is selected, for example, all sounds will be played back using the sound card of the local computer and the computer keyboard will be used to control the server (via numeric buttons instead of DTMF keyboard). This mode is primarily for system testing purposes.

If one of the modems is selected, for example, all sounds will be played back into the phone line using the selected modem, and the calling party's phone keyboard (DTMF tones) will be used to control the server. This is the normal mode of server operation.

The answering of incoming calls is performed differently in the local and the normal modes. In the local mode, the application waits for the ‘R’ key to be pressed to simulate remote party RING, while in the normal mode, the application waits for the RING signal from the modem. Then, in either mode, the application initializes the device used (e.g., sound card or modem). In the latter case, the modem goes “off-hook” and plays back the greeting message and the main menu 15 (e.g., 0—End of the session, 1—Current, 3—Next, 4—Load).

Thereafter, the application goes into calling party servicing loop. Exit from the loop is possible upon reception of DTMF code ‘0’ (or its simulation using the keyboard) or after a 30-seconds timeout if no reaction is detected from the remote user. Additionally, if working with the modem, the loop is exited when short beeps (“BUSY”) condition is detected on the phone line. In the local mode, the ‘X’ key also leads to the immediate exit of the application.

The calling party servicing algorithm may preferably work as follows: the software keeps the internal counter or number of the current sound and/or image files. Initially, this number is “0” indicating that the file is at the top of the list. Upon receiving the “1” command, the software plays back the file with the current number. Upon receiving the “2 command, the software increases the number and plays back the file, e.g., plays a next file. Upon receiving the “3” command, the software decreases the number and plays back the file, i.e., plays the previous file.

Upon receiving the “4” command, the audio and/or image file download is simulated. For the obvious reason, this mode is not implemented yet. Upon receiving the “0” command, the application switches the modem “on-hook” releasing the phone line and returns to the incoming call waiting state. Upon encountering any other command, the application plays back a standard error message. At any moment, the server application can be aborted by pressing <Ctrl>C combination on the keyboard.

Preferably, the server application keeps a log file (e.g., named “ProgramName_N. Log”) where N is a port number. Therefore, if two instances of the application are started, one for the modem on COM1 and the other for the modem on COM2, two independent log files will be created. The log file contains brief information about user and server actions, times of events, their main features, for example, state of the modem, for example, or the sound card. These files are intended to be sent to the software developers in case of problems but can be used for other purposes as well, for example, to estimate the server load.

Due to the fact that the server application often plays a sound and/or image file with the same quality as one would be able to hear or view through the conventional phone channel [monophonic, 8 kHz-sampling rate (signal bandwidth up to 3.7 kHz)], the sound and/or image quality of the played back files may not be up to one's preference, or at least not what one may consider being of the highest desirable nature. This is not related in any way with the quality of sound and/or images that would be digitally transferred to the client's phone when the sound file is selected, or upon selection of an image file, since listening to the files or viewing files from server through the phone network may not deliver better quality than the phone channel itself. For this reason, for example, in the case of a sound file, sound files compressed in monophonic versus stereo form would be preferred since the rate of delivery would be faster, with no loss in playback quality from the phone. At the same time, when sound and/or image files are downloaded into the phone in digital form, significantly better quality could be delivered upon playback due to the perceptual compression; however, the transfer time may be longer.

The server software could also be implemented to track which files were sent to which user or subscriber. This information could then be tracked and reported to different third parties such as the Copyright Office, or performing or artist's rights organizations or societies.

### Devices for Accessing Sound and Image Files

Electronic devices adapted to receive sound and image data (inclusive of videos, as defined above) according to the present invention, may be provided with an attachment or built in mechanism for providing consumers with Internet-based or Internet-free access to a library of downloadable sound and/or image files. Consumers may be allowed to download free clips of a song, musical composition, or other sound recording or movie or other performance, or any visual display onto any of these devices for use as alerts, e.g., ringtones, or for any purpose desired or contemplated.

In accordance with a preferred embodiment of the invention, after hearing or viewing a clip, the user, preferably by the push of a button, may transact a purchase of the full file associated with the clip, which may be downloaded to the device in its entirety, or delivered to the user's address on an independent medium such as records, cassette tapes, CDs, videotapes, and DVDs. Such practice is intended to encourage the sales of sound and image files by giving the user the opportunity to quickly make an impulse purchase.

One preferred device for downloading and listening to music files, in accordance with the invention, which is similar to a walkman type IPod™ device, but uses the same delivery method via compression algorithms as described for the cellular phone, comprises a speaker and/or an earphone set for listening to music with volume controls (such as Bose or Shure E5 universal earphones), and a server access element (which may be approximately the size of a credit card). Such a device may be used as a hand held portable music and/or video player, as well as a car radio or home system, and may include larger speakers for use as an audio system by businesses such as bars, restaurants and clubs, and unlike an iPodTM, may be used wirelessly, over-the-air with or without an Internet connection.

In addition to features which allow a user to access the server library, the device may include other features common to conventional MP3 players (or similar digital compression players using compression formats different than MP3) and/or Apple iPod™ devices. The server access element includes controls, which may be buttons, for accessing, browsing, and downloading files from the server to the device. Speed dial technology may be used for accessing the server.

For browsing, a multi-task arrows button, which allows the user to browse, listen to and/or view samples, and highlight specific selections, may be provided.

The server access element may include a small LCD monitor (approximately 1″×1.75″) for text and/or image browsing the server library. A small microphone hole may also be included for allowing the user to browse the library using voice commands. The earphone set or speaker will enable the user listen to and view downloaded sound and/or image files.

Downloaded files may be stored on a device storage list for accessing at all times, or deleted. Thus, the user may access a library containing a large number of sound and/or image files, and browse, download, and listen to music, and/or view videos and other visual content without the Internet, an ISP connection or the need to plug into a computer. The consumer may be charged a fee for each download, or may be able to purchase actual items, for delivery to an address indicated by the user, such as records, cassette tapes, CD's and DVD's through the access element. Free clips of sound and/or image content, such as segments of songs or movies which the user can download, may induce the consumer into purchasing the entire sound and/or image file from where the clip originated.

The device may also include a mechanism for allowing a user to store downloaded files on a medium, such as a card, independent of the device. To this end, the device may provide a slot into which a storage card may be inserted, such that when the device is full, files may be downloaded onto the card for emptying space on the device. A security mechanism may also be included to prevent intellectual property abuse, for example, by preventing users from playing copied files on other devices as described above. Such devices may further include a monitoring feature, which would allow performing rights organizations such as ASCAP and BMI to keep track of music publicly played by business such as bars, restaurants, and clubs for the purpose of paying out royalties.

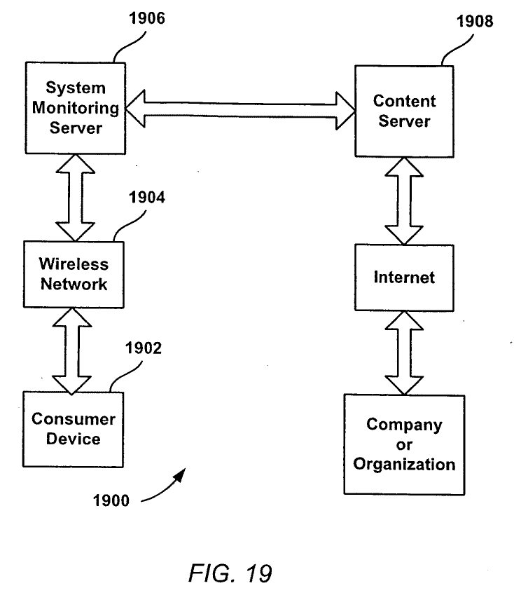

A preferred embodiment of a schematic diagram for a media file monitoring system 1900 is shown in FIG. 19, for use with an (iPod™-type) listening device 1902, wherein a consumer may purchase, in accordance with the invention, copyright registered media files which are downloaded wirelessly to the device 1902. The system 1900 includes an existing Wireless network 1904 preferably of 1.5G or more, a system monitoring server 1906, and a system content server 1908. The monitoring server 1906 monitors and counts every file delivered to the consumer device 1902, for monitoring and counting every file delivered to the device 1902. The server 1906 may track each individually titled file, which may include information such as song or movie or video title, artist name, purchase price, the consumer's name, and other identity information, time of delivery, and any other pertinent information. The server 1906 may also protect encrypted copyrighted files from illegal file copying. The content server 1908 stores copyrighted digital media content e.g., audio and/or visual content, licensed from multiple entertainment companies. Thereafter, monitoring information, including statistics may be transmitted (e.g. through the Internet) to a company or organization. As mentioned, the system described also applies to a viewer device for monitoring image files.

A portable viewer device, for accessing and viewing image and/or sound files, may comprise a wireless earphone set and/or speaker for listening to programs with volume controls, and a Personal Digital Assistant (PDA) or similar device, such as a Blackberry type device or any cell phone with a viewer display, larger devices which may be equipped with a monitor which may be approximately the size of a laptop computer. This device allows the user to access a server library containing a large number of movies, TV shows, cartoons, and other files, using either text or voice activation, without the need to plug into a computer or use of the Internet or other computer based telecommunication system.

The files may be categorized and subcategorized by type of file (i.e. movies, TV shows) then by title or name of main actors. TV shows may further be classified by providing a description for each episode, similar to a description provided in a TV GuideTM. Other categories and subcategories of classification may be provided to allow the user to identify the exact file he wishes to access.

The device allows the user to browse, download, preview, store and view selections, (using text, voice, or button commands), wherein a fee may be charged by the provider for any or all of these options. The files may be made available as clips as well as in their entirety. The viewer device may include a folder containing previously downloaded image files, or sound and/or image files, that can be accessed at any time and deleted when desired. The library may be organized by categories such as type of show (i.e. movies, TV sitcoms), names of actors, show titles, sitcom description (e.g. as appearing in TV Guide™) etc.

Method of Advertising using Delivery of Sound Clips

The method of delivering sound and image files, in accordance with the present invention, can further be utilized as an advertising tool. To this end, any of the above-described systems carrying a library of sound and/or image files, which include a website and non-Internet accessible holding unit, may be used to expose the user to sponsored advertising messages. For example, a user calling the holding unit may hear advertising while the system is accessing the library.

Other advertising opportunities may be provided by utilizing a phone or other electronic device using alerts or ringtones according to the present invention. For example, a phone may ring with advertising gimmicks such as promotional messages. Such advertising gimmicks may be played as default rings when no clip is selected for the ring. Additionally, a phone may be programmed to play, or transmit advertisements spontaneously: Clips containing advertising messages such as jingles may also be provided. Advertising messages may be tacked onto a user selected clip of a popular song or the like, or as mentioned above, may play to a phone user in return for the user receiving free music, movies or games and the like, such as performed in traditional television advertising.

### Method of Distributing Music and Audiovisual Works to Consumers

In yet another aspect of the present invention, there is provided a method of distributing music and audiovisual works to consumers while accounting to copyright owners of the works, comprising: (a) making available on a website various selections of works in various categories for review by identifying information, and offering a portion of the work for hearing, listening and/or viewing, with each work being coded internally with identification to a copyright owner or its representative; (b) allowing consumers to select the viewable or listenable portion of the work for data storage online or for downloading to the consumers' electronic devices wherein the downloaded file may be encrypted to only play on the consumer's electronic devices first receiving the download; (c) optionally tracking those consumers who received the download of the portion of the work and reporting to the copyright owners or their representatives information concerning the download; (d) allowing a consumer to return to the website to purchase and download a complete copy of the copyrighted work previously sampled by the consumer; (e) conducting an online purchasing transaction and charging the consumer for the download; (f) downloading a complete copy of the copy-righted work to the consumer in an encrypted fashion so as to be playable only in the consumer's electronic device and not exchangeable with third parties; (g) tracking those consumers who received the download of the copyrighted work and reporting to the copyright owner of their representatives information concerning the download; and (h) paying the copyright owners or their representatives a portion of the money received from the consumers for their downloading of the copyrighted work.

### Method of Playing User Selected Sound Files on Radio

In a further aspect of the invention, there is provided a device containing stored sound files, which may further include broadcasting capabilities, for broadcasting sound files to a local radio at a set frequency. In accordance with a preferred embodiment, such device will be a small box which may contain a large number of user sound files, and will be capable of broadcasting only over a short distance, say approximately 1-15 feet. Thus, a user will be able to keep the box essentially anywhere its use may be desired, such as, for example, in a car, in a boat or near a home system, which includes a radio, and broadcast selected files to a specific radio station at which the box is set to broadcast. This will enable the user to play sound files which were selected and stored on the box on a regular radio, without the use of CD tapes. Since a large number of CDs are capable of being stored on the box, according to the method of the present invention, the number of sound files which a user of the box would have access, to, for instance, in his car, would far exceed the number of songs available on CDs which the user can practically carry in his car. Additionally, the system, though broadcasting to a radio, will avoid any FCC legal violations since the broadcasting may only be done at a very short range, and hence, only to a radio or radios which are very close to the box. This box may be of various sizes, as desired.

Additionally, the sound quality can be made almost indistinguishable from CD quality using a parametric optimization algorithm, wherein the sound file may be optimized to work with the speaker system. As such, the sound quality will depend on the speaker quality. This system may use digital radio, start with FM and convert to digital or other methods, as desired.

### Client Software Application for Advanced Cellular Phones

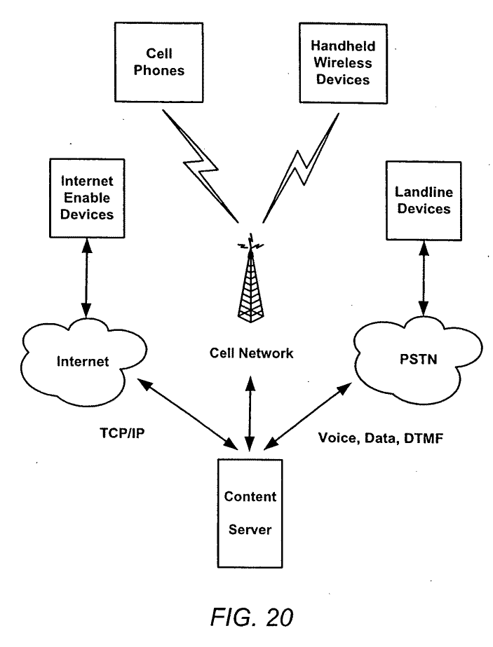

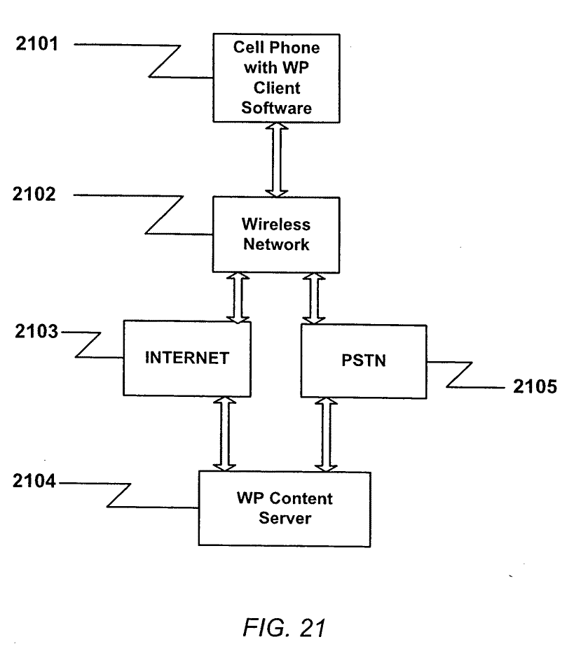

In an additional aspect of the present invention, a software-only based client application for encoding into cellular phones with delivery, storage, and playback capabilities is described below. FIG. 20 is a conceptual diagram of a preferred embodiment of the overall system 2000, including a cell phone 2001 and other devices, which may access a content server 2104. FIG. 21 is a schematic diagram illustrating in a preferred embodiment the basic components of an advanced cell phone system having desired delivery, storage, and playback capabilities. The system is comprised of a cellular phone 2101 running client software, a system content Server 2104 with server software and data transportation networks 2102, 2103, and 2105.

The phone user may access the content server 2104, which includes sound and/or image files, by operating the client software application installed on cellular phone 2101. The server 2104 may display a list of sound and/or image files on the display screen of the cellular phone. The user can request the server 2104 to download a selected sound and/or image file. This request may be issued from the client software installed on cellular phone 2101. A cellular phone 2101 is specified by subscriber identity information from a cell phone smart card, such as a SIM (Subscriber Identity Module) Card, which maybe inserted into GSM cell phones and contains telephone account information. This enables the server 2104 to recognize the particular cellular phone 2101 and download a sound and/or file to that phone.

Further, preferably, the client software installed on cellular phone 2101 is a hardware independent, client software-only solution and requires no particular hardware in the host cell phone 2101. It uses a general model of the advanced cell phone's audio and visual output hardware and a set of host interface functions to adapt each implementation to the particular cell phone audio and visual output system. Since Smartphones (also known as advanced phones, 2.5, 3G or 4G6 phones, or most cell phones today) may oftentimes integrate a fully-featured personal digital assistant (PDA) and traditional mobile phone in one unit, an operating system of such phones is open for third-party development of additional applications and services (in contrast to operating systems of previous phone generation, adopted by mobile phone manufacturers several years ago). For example Symbian OS supports standard languages such as C++ and Java, along with SDKs, tools, documentation, a rich set of APIs and technical support for independent software developers.

The software 2101 may use a multimode telephony interface or API (Application Program Interface). This API abstract cellular network preferably includes GSNI (Global System for Mobile Communications), EDGE (Enhanced Data rates for Global Evolution), CDMA (Code Division Multiple Access), W-CDMA (Wideband-CDMA), and UNITS (Universal Mobile Telecommunications System), and makes it easier to move the software 2101 from one mobile phone standard to another.

The cell phone API encapsulates communication between the software 2101 and cell phone hardware. This enables branded audio and visual content such as recorded music and spoken word recordings, videos, movies and animations and the like. It also can be used to trigger playback of digital audio and/or visual recordings in response to program conditions, for example, audio caller ID functions, a device audio logo or animation or video that is placed upon power up, or recorded pop music clips and files that play when buttons are pressed, etc. As such, the cell phone API provide a possibility to switch and synchronize dynamically different functions of cell phone, such as caller ID function, digital audio playback function, digital audio and/or visual recording function, etc.

Because many presently available cell phones contain both DSP and microprocessor hardware, the software 2101 may be optionally split into two parts: a microprocessor module containing the master functions and a DSP module containing all audio and image rendering functions. Communication between the two modules is achieved by means of API communications.

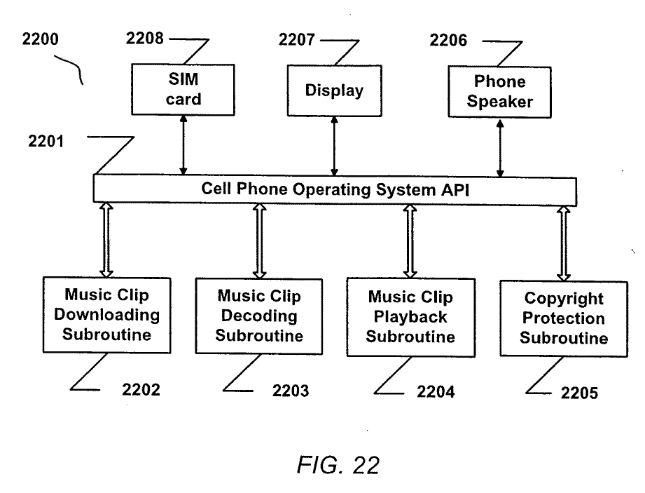

In another preferred embodiment, a schematic diagram illustrating the system 2200 for the client software 2101, is shown in FIG. 22. The system 2200 includes a cell phone operating system API 2201, a sound and/or image file downloading subroutine 2202, a sound and image file decoding subroutine 2203, a sound and image file playback subroutine 2204, a display unit 2207, and a phone speaker 2206. The system may further include a copyright protection subroutine 2205, and a SIM card interface 2208. The cell phone OS (operating system) 2201 preferably meets common requirements for advanced 2.5G and 3G mobile smart phones OS that includes a multi-tasking kernel, integrated telephony support and communications protocols. (Symbian' OS or Windows' CE are examples of such systems).

The software 2101 preferably uses the following system API of cellphone OS:
Multimedia API—This provides for sound playing and manipulation, image manipulation, and format conversion.
Graphics API—This provides for drawing capabilities including the drawing of lines, shapes, text, and bitmaps. This also provides access to the Window's 15 server and animation APIs.
Telephony API—This provides a generic interface to initiate, control, and terminate telephone calls. Also, a client can get status and capabilities information, and can be notified of changes.
Networking API—This provides multimode cellular telephony network interface, making it easier to move the software application 2101 from one mobile phone standard to another. This also provides TCP/IP (Transmission Control Protocol/Internet Protocol) communication services in conjunction with the Sockets Client API.

The sound and image file downloading subroutine 2202 provides for browsing of the content server 2104, and selecting and downloading of sound and image files utilizing XHTML/HTML browser capabilities. The subroutine 2202 utilizes Networking API for interaction with content Server software via a TCP/IP protocol or Telephony API for interaction by means of the PSTN. A graphical user interface is implemented by using Graphics API. Subroutine 2202 also interacts with the copyright protection subroutine 2205.

The sound and image file decoding Subroutine 2203 preferably utilizes Multimedia API to provide sound and image file decoding in correspondence with the above mentioned procedure for Audio Data Parametric Optimization and Compression (method 1600). The subroutine 2203 is preferably activated via a request from the copyright protection subroutine 2205, wherein the subroutine 2203 decodes the sound and/or image file and activates subroutine 2204 for playback of the sound and/or image file.

The sound and image file playback subroutine 2204 provides for the interception of an incoming call signal using the Telephony API, and playback a of a correspondent sound and/or image file via phone speaker system 2206 and/or display unit 2207, such as in accordance with a caller ID setup, and utilizes the Multimedia API and graphical user interface by using Graphics API and the display 2207. Subroutine 2204 also interacts with the sound and image file decoding subroutine 2203 and the sound and image file downloading subroutine 2202. The copyright protection subroutine 2205 prevents the unauthorized playback and reproduction of digital sound and image files, and prevents the sharing of protected files, such as music files, between cellular phones and other mobile devices. Subroutine 2205 uses subscriber identity information of the telephony SIM card 2208 as an authorization key that would enable the user to be authorized.

The copyright protection subroutine 2205 transmits the user's authorization key to the content server 2104 when the user requests the server to download a selected sound and/or image file. After the file has been downloaded from the server to the cell phone, subroutine 2205 receives the file from subroutine 2202, provides decryption of the file, extracts the file authorization key and compares the key with the actual subscriber identity information. If the comparison matches, subroutine 2205 transfers the file to the sound and/or image decoding subroutine 2203.

The content server 2104 is a computer running server software that is designed to execute requests of the client software 2101 of the cell phone 2100, which may be given through TCP/IP protocol or using DTMF signals of the phone keys as described above and shown in FIGS. 3 and 13.

The system 2200 enables a connection to the server 2104 upon a request from the client software 2101 of the cell phone. The server 2104 provides for content browsing, selecting and downloading of sound and/or image files to the cell phone 2101 through the Internet 2103 or through the PSTN 2005 (FIG. 21). The server further allows for files to be transmitted to the cell phone 2101 utilizing client software authorization and support. The server may store or be capable of accessing a sound and/or image file database.

The Server 2104 preferably utilizes sound and image file optimization and compression algorithms, shown in FIG. 16, which converts common sound and image files into compressed files that are downloaded and stored under a user's request by the client software to the cell phone 2101.

Also the server software may provide copyright protection functions. When the user requests the server 2104 to download a sound and/or image file, the server software requests user's authorization key from the client software 2101, inserts the authorization key into the file, encrypts the file and then uploads the encrypted file to the cell phone 2101.

The delivery system, according to the present invention will further integrate with future wireless and telecommunications technology, such, as it becomes available, for offering enhanced capabilities for accessing, delivering, and using sound and image files.

In a further aspect of the invention, there is provided by the inventive products, methods and system unheralded, and heretofore unavailable, valuable advantages in conducting any of an extensive array of business functions and methods, such as novel subject matter in forming business entities, such as corporations, partnerships and LLCs, for use in generating valuable trademark rights and business goodwill, and for use in music and movie sales and the like.

While the present invention has been described with reference to exemplary embodiments, it will be understood that various changes and additional variations may be made and equivalents may be substituted for elements thereof without departing from the scope or the concepts disclosed herein. In addition, many modifications may be made to adapt a particular situation or material to the teachings of this disclosure without departing from the essential scope thereof. Therefore, it is intended that the disclosure not be limited to particular embodiments disclosed herein for carrying it out, but that the disclosure includes all embodiments failing within the scope of the appended claims.

What is claimed is:

1. A method of wirelessly delivering over the air a digital audio and/or visual file comprising one or more of full or partial master recordings of songs, musical scores or musical compositions, one or more full songs, CD tracks, videos, one or more images, DVD tracks, television shows, human voice, personal recordings, cartoons, film animation and combinations thereof,
from one or more servers to an electronic device comprising,
storing said audio and/or visual file in compressed and optimized format in one or more storage mediums,
wherein said digital audio and/or visual file or files is compressed by one or more algorithms effective for compression and over the air wireless delivery of said files, and said digital audio and/or visual file or files is optimized by one or more algorithms effective for optimization of said files for said over the air wireless delivery, and
delivering said compressed and optimized audio and/or visual file over the air, wirelessly, with or without an Internet connection to a storage medium accessible on demand by an electronic device effective to receive and playback the audio and/or visual file or files.

2. The method of claim 2 further comprising storing the file on the electronic device.

3. The method of claim 2 further comprising providing selection of the delivery of one or more compressed and optimized digital audio and/or visual files for playback on said electronic device.

4. The method of claim 3 further comprising providing playing back of one or more of said selected compressed and optimized digital audio and/or visual files.

5. The method of claim 1 further comprising providing said compressed and optimized digital audio and/or visual file as an alert message or ringtone for the electronic device effective to signify the occurrence of a specific event.

6. The method of claim 5 wherein said electronic device is a cell phone, and wherein said compressed and optimized digital audio and/or visual file is played as an alert or ringtone of an incoming telephone call.

7. The method of claim 6 wherein a segment of a compressed and optimized digital audio and/or visual file is played as an alert or ringtone of an incoming call.

8. The method of claim 7 wherein said segment is played a plurality of times as an alert or ringtone of an incoming call.

9. The method of claim 6 wherein said alert or ringtone is associated with a specific caller's telephone number, and is played upon said specific caller calling said cell phone.

10. The method of claim 9 wherein a plurality of compressed and optimized digital audio and/or visual files are delivered and stored on said cell phone, and wherein a specific audio and/or visual file of said plurality of files is associated with a specific caller calling said cell phone and is effective to play when said specific caller calls.

11. The method of claim 6 further comprising said cell phone being shared by a plurality of cell phone users, wherein a plurality of compressed and optimized digital audio and/or visual files are delivered to and stored on said cell phone, and wherein a specific audio and/or visual file of said plurality of files is associated with a specific user of said plurality of users, and wherein said file is effective to alert a user of said cell phone to an incoming telephone call wherein said specific user is the intended recipient of said incoming call

12. The method of claim 1 wherein said electronic device is selected from a cell phone, personal computer, laptop computer, hand held computer, desktop computer, PDA, wireless digital audio and/or visual player, palm pilot, personal calendar, clock, watch, pager, door bell, car alarm and other electronic devices suitable to store data and to communicate wirelessly via the electromagnetic spectrum.

13. The method of claim 1 wherein a plurality of compressed and optimized digital audio and/or visual files are delivered to and stored on the electronic device.

14. The method of claim 1 wherein said compression is selected from MP3 and any and all effective alternative forms of compression.

15. The method of claim 1 wherein said compressed and optimized digital audio and/or visual file is delivered through the Internet or other computer based system.

16. The method of claim 1 wherein said compressed and optimized digital audio and/or visual file is delivered to said electronic device independent of an Internet connection or other computer based system.

17. The method of claim 1 wherein said compressed and optimized digital audio and/or visual file is a personal recording or video.

18. The method of claim 1 further comprising charging a fee for the use of said wireless electronic device, wherein said fee is based on the number of compressed and optimized digital audio and/or visual files delivered to said electronic device for playback thereon or the duration of playback of said compressed and optimized digital audio and/or visual files.

19. The method of claim 1 wherein the compressed and optimized digital audio and/or visual file is a segment of a full song, musical composition, other audio recording or visual recording.

20. The method of claim 19 wherein the purchase of an item associated with said compressed and optimized digital audio and/or visual file may be transacted upon said digital file being heard or viewed.

21. The method of claim 3 wherein said compressed and optimized digital audio and/or visual file may be selected for delivery from said wireless electronic device for play thereon without using an Internet connection.

22. The method of claim 21 wherein said digital audio and/or visual file may be selected from the wireless electronic device on a voice mode connection without switching to data mode.

23. The method of claim 22 wherein said digital audio and/or visual file is delivered to the wireless electronic device using a transmission protocol that maps digits to sounds.

24. The method of claim 23 further comprising an orthogonal frequency-division multiplex modulation scheme.
